(19) United States
(12) Patent Application Publication
(10) Pub. No.: US 2008/0254080 A1
(43) Pub. Date: Oct. 16, 2008

(54) Novel Uses of Calcium Hydroxide

(76) Inventors: Bryan C.G. Glynson, Aventura, FL (US); Alis A. Yeterian, Aventura, FL (US); John L. Sigalos, Dallas, TX (US); William A. Mallow, Comfort, TX (US); Nancy Mallow, Comfort, TX (US)

Correspondence Address: T. Ling Chwang;Jackson Walker, 901 Main Street, Suite 6000, Dallas, TX, 75202, US

(21) Appl. No.: 11/667,089

(22) PCT Filed: Nov. 4, 2005
(86) PCT No.: PCT/US05/40244

§ 371 Date: Feb. 27, 2008

Related U.S. Application Data
(60) Provisional application No. 60/624,991, filed on Nov. 4, 2004.
(60) Provisional application No. 60/648,473, filed on Jan. 31, 2005.

(51) Int. Cl. A01N 59/06; A01P 3/00; A01P 7/04; A01P 1/00; A01N 25/34; C09D 5/14; C09D 1/12

(52) U.S. Cl. 424/404; 424/694

(57) ABSTRACT

A heating ventilation and air conditioning (“HVAC”) system having bacterial spore, viral, and fungal killing activity. The HVAC system components are at least partially coated with a biocidal composition having hydrated lime, soluble binder polymer mixture and humecatant are mixed in either an organic based- or water based-solvent system that is useful for coating HVAC system components.

### RELATED APPLICATIONS

This application claims priority to U.S. Provisional Patent Application, Ser. No. 60/624,991, entitled “Novel Uses of Calcium Hydroxide” filed on Nov. 4, 2004, having Mallow W (deceased), Sigalos J. L., Glynson, B. C. G, and Yeterian A. A., listed as the inventor(s), the entire content of which is hereby incorporated by reference.

### STATEMENT OF RIGHTS TO INVENTIONS MADE UNDER FEDERALLY SPONSORED RESEARCH

This invention was NOT supported by federally sponsored research.

### BACKGROUND

One aspect of this invention is a chemical biocidal coating that prevents microbes from growing on the surface of such biocidal coating. More specifically, the biocidal coatings contain calcium hydroxide, which give the coating a dual property capable of; (i) killing microbes that were present on a biocidal coating treated substrate and (ii) preventing the future growth of on the biocidal coating such as bacteria, funguses, algae and viruses.

Bacteria. Bacteria are considered any of a division of monerans, microorganisms that are typically one-celled, have no chlorophyll, multiply by simple division, and can be seen only with a microscope. Bacteria generally occur in three main forms, spherical (cocci), rod-shaped (bacilli), and spiral (spirilla). Some bacteria cause diseases such as pneumonia and anthrax, and others are necessary for fermentation, nitrogen fixation, etc.

Bacteria under “normal” growing conditions are very active organisms that are capable of doubling every twenty minutes. Similarly, even in a so called “vegetative state,” bacteria are relatively active organisms having a metabolism that continues to utilize nutrients and water through a porous outer membrane. When bacteria are in the vegetative state, they are susceptible to being attacked and killed through their porous outer membrane. Some bacteria may enter a “spore state” when the environment becomes inhospitable. The spore state has evolved over billions of years to help bacteria survive hard times by encasing the genetic material within a hard and relatively impermeable membrane. Additionally, the metabolism of bacteria drops to barely perceptible levels during the spore state, which makes them very difficult to kill.

The anthrax bacillus, Bacillus anthracis, was the first bacterium shown to be the cause of a disease. In 1877, Robert Koch grew the organism in pure culture, demonstrated its ability to form endospores, and produced experimental anthrax by injecting it into animals. The bacteria Anthrax bacillus has both a vegetative state and a spore state. The anthrax bacillus spore is particularly hard to kill, having an outer membrane that is relatively hard and impermeable as compared to other bacterial spores. Anthrax spores are capable of germinating after decades of inactivity in a dry, undisturbed state. Humans can become infected with anthrax by handling products from infected animals or by breathing in anthrax spores from infected animal products (like wool, for example). People also can become infected with gastrointestinal anthrax by eating undercooked meat from infected animals. Unfortunately, anthrax bacillus spores can be purified by terrorists and used as weapons to kill citizens of the United States. Most current methods of killing anthrax spores, such as radiation and fumigating with formaldehyde or chloride dioxide gas, may be effective but are expensive, ecologically damaging, dangerous for occupants and causes a long-term damage in the environment in which is being used. The United States faces a national crisis that requires new ways to passively and inexpensively kill anthrax spores, as well as spores of other virulent microorganisms, such as those of the genus clastridium which cause tetanus, gangrene, and botulism as well as spores of infectious molds and fungi.

In Estrela, Bammann, Estrela, Silva, and Pecora, Antimicrobial and Chemical Study of MTA, Portland Cement, Calcium Hydroxide Paste and Sealapex and Dycal, Braz Dent J(2000) 11 (1) 3-9 155 N0103-6440, several antimicrobial agents were tested in agar diffusion tests against different bacterial strains including Bacillus subtilis. The paper concluded that the “antimicrobial activity of calcium hydroxide over all microorganisms studied was superior to that of . . . [the other antimicrobial agents].” Anthrax bacillus spores are less resistant to antimicrobial activity than are Bacillus subtilis spores. Thus, it is hypothesized that calcium hydroxide can be usefully used to kill anthrax spores. The test of the Estrela paper, however, concerned hydrated spores. In principle, completely dry calcium hydroxide and completely dry anthrax spores may be thoroughly mixed without the dry calcium hydroxide injuring the dry Anthrax spores because there is no means for communicating hydroxide ions from the calcium hydroxide to the spore.

Fungi. Fungi are any of a large division (Eumycota) of thallophytes, including molds, mildews, mushrooms, rusts, and smuts, which are parasites on living organisms or feed upon dead organic material. Fungi lack chlorophyll, true roots, stems, and leaves, and reproduce by means of spores. In some systems of biological classification, these organisms are placed in a separate kingdom (Fungi) and are not considered to be plants.

The current invention shows fungal growth is decreased on fruit when the fruit is kept in boxes having the biocidal coating described herein. For example, two boxes [were used that werer either coated with a biocidal coating or void of a coating.]??? Results indicated that the box lined with biocidal treated paper on both bottom and sides of box indicated drastically less fungal growth when compared to the non biocidal treated box after 1 through 7 days.

Viruses. The present invention is effective at killing many different viruses when contacted by a biocidal treated surface. Generally, viruses can be killed in a relatively short period of time after contacting the biocidal treated surface. Using biocidal coated surfaces to control the spread of viruses is important in today's world wide economy. For example, the H5N1 virus does not usually infect humans, and the risk of contracting H5N1 virus from birds is relatively low. However, in 1997, the first case of spread of H5N1 virus from a bird to a human was seen during an outbreak of bird flu in poultry in Hong Kong. The virus caused severe respiratory illness in 18 people, 6 of whom died. Since that time, there have been other cases of H5N1 infection among humans having a significant death rate associated with the bird virus. Most recently, human cases of H5N1 infection have occurred in Thailand, Vietnam, Cambodia, Turkey and Europe. More importantly, the death rate for these reported cases has been about 50 percent. Most of these cases occurred from contact with infected poultry or contaminated surfaces. This specific virus has not yet mutated to be transmitted from human-to-human. However, if a human-to-human variant of the H5N1 appears, the world health organization predicts that a world-wide pandemic will occur at a cost of hundreds of millions of human lives. The present invention has been shown to kill viruses in the same category that cause the H5N1 viral stain after exposure and contact with biocidal treated surfaces of this invention.

U.S. Pat. No. 6,280,509, titled “Biocidal Coating Compositions and Method,” issued to Mallow on Aug. 28, 2001, (“the '509 Patent), described a biocidal paint. The biocidal film-forming composition of the '509 Patent is a paint containing hydrated lime and a non-ionic polyolefinic latex resistant to hydrated-lime induced coagulation and phase separation. Also disclosed is the method of making certain such composition wherein hydrated lime is admixed with a non-ionic polyolefinic ester latex with agitation and continuing such agitation until hydrolysis of the ester is substantially completed and rheology of the composition is stabilized.

U.S. Pat. No. 6,231,650, titled “Biocidal Coating Composition,” issued to Mallow, et al. on May 15, 2001, (“the '650 Patent”) described a hydrated lime paint or coating that was safe for public use, and which would last for longer than traditional white washes. Although not wanting to be bound by theory, the invention of the '650 Patent involved specific binders that could block the passage of carbon dioxide into the coating, preventing carbon dioxide from reacting with lime either in the coating itself, or in an underlying substrate. The binders were also surprisingly compatible with hydrated lime, and render the coating durable and adhesive upon drying.

U.S. Pat. No. 6,042,638, titled “Biocidal Coating Composition,” issued to Mallow, et al. on Mar. 28, 2000, (“the '638 Patent”) described a prolonged biocidal activity of hydrated lime in a paint or coating by using a sufficient amount of a binder in the paint or coating to block carbon dioxide from reacting with the hydrated lime while still producing a coating that is durable and adhesive upon drying and not unduly friable due to the amount of hydrated lime in said coating

U.S. patent application Ser. No. 10/476,732 titled “Stabilized Biocidal Coating Composition and Method” with Mallow et al., listed as inventors and filed on Jun. 1, 2004, (“the '732 Application”) describes a biocidal film-forming composition, preferably a paint, that is comprised of hydrated lime, alkaline potassium salt, and a non-ionic polyolefinic latex resistant to hydrated-lime induced coagulation and phase separation. Also disclosed in the '732 Application is a method of making certain compositions using hydrated lime admixed with a non-ionic polyolefinic ester latex with agitation and continuing such agitation until hydrolysis of the ester is substantially completed and rheology of the composition is stabilized and the incidence of gelation is eliminated.

The invention described herein has utilized calcium hydroxide as an ingredient in chemical coatings can be used to coat surfaces (e.g. architectural walls, equipment, containers, tables, etc.) or be incorporated into clothing (e.g. gloves, aprons, decontamination suites, etc.) which can kill bacteria, fungus, algae and viruses for an extended period of time.

### SUMMARY

The invented calcium hydroxide coating provides a self-sterile, septic, self-disinfected surface that retains this ability for extended period of time and prevents microbes from breeding and growing on its surface. It may be effective in reducing anthrax, tuberculosis, staphylococcus, and similar infectious pathogens. There is a long felt and unmet need for passive, inexpensive, safe systems which have this effect.

One aspect of the current invention involves a heating ventilation and air conditioning (“HVAC”) system having bacterial spore, viral, algae and fungal killing activity. The HVAC system component at least partially coated with a biocidal composition having a hydrated lime, a soluble binder polymer mixture; and a humectant. In some aspects, about 35 percent to about 40 percent latex is also included. The hydrated lime, the soluble binder polymer mixture and humecatant are mixed in an organic based- or water based-solvent system useful for coating HVAC system components. The ratio of lime to soluble binder polymer being about 1:1 to about 1:3, and the humectant being 15.5% to 25% wt percent of the chemical coating. The chemical coating is permeable to water and substantially impermeable to carbon dioxide. One of ordinary skill in the art knows there are several components to an HVAC system that could be coated with the biocidal coating, for example: entire inner wall of duct work system, a return air chamber; fresh air chamber mixing box air chamber; coils coil compartment; fan housing; humidifier chamber; dehumidifier chamber; spray eliminator; filters housing; louvers; HVAC supply and return ductwork; dampers turning vanes; exhaust ducts; dampers; baffles; filters; fans fan housings; and wall floor registers ceiling diffusers. The HVAC system being treated with such biocidal coating has ability to be effective against wide spectrum of microorganisms, for example: bacteria, fungi, algae, viruses bacillus subtilis which is the surrogate of anthrax spores; pseudomonas aeruginosa; staphylococcus aureus; samonella cholerasuis; escherichia coli; streptococcus faccialis; klebsiella phneumonia; legionella pneumophila; alternaria alternate; aspergillus spp.; clodosporium spp.; aureobasidium pullulans; Penicillium funicullatum; stachybotras chartarum; influenza type A2; rhinovirus; rotavirus; adenovirus type 2; respiratory syncytial hepatitis; polio virus type I herpes virus hominis type I; parainfluenza and virus type III, and H5N1 virus.

A second aspect of the current invention involves a garment having bacterial spore, viral, and fungal killing activity. The garment is at least partially coated with a biocidal composition having a hydrated lime, a soluble binder polymer mixture; and a humectant, as described above. Some of the garments that could incorporate the biocidal coating include aprons, pants, shirts, jackets, coats, gowns, gloves, hats, shoes, boots, and socks. In one embodiment, the garment has a first side that includes the outside of the garment and the second side comprises the inside of the garment. These garments have bacterial spore, viral, and fungal killing activity that is effective at least against the organism listed above.

A third aspect of the current invention involves a hospital room articles having bacterial spore, viral, and fungal killing activity. The hospital room articles are at least partially coated with a biocidal composition having a hydrated lime, a soluble binder polymer mixture; and a humectant, as described above. The hydrated lime, the soluble binder polymer mixture and humecatant are mixed in an organic based- or water based-solvent system useful for coating hospital room articles, such as: architectural walls; handles; medical equipment; desks; computer keyboards; plastic covers for computer keyboards; privacy curtains; window blinds; window curtains; hospital furniture; or janitorial equipment.

The current invention discloses surprising new uses of biocidal coatings based on calcium hydroxide which, in spite of the great need for such biocidal coatings and methods, have not previously been introduced. The usefulness of the biocidal activity of the biocidal coatings described herein will be apparent to those of ordinary skill in the art.

It has been surprisingly hypothesized that the calcium hydroxide based coatings described herein effective to kill surrogate of anthrax spores and other virulent spores in ways which are surprisingly practical if the area of contact between such spores and the calcium hydroxide is properly hydrated to provide a vehicle to communicate the calcium hydroxide's high alkalinity into the spore and is properly protected from atmospheric air to protect the calcium hydroxide from carbonation.

To appreciate the several inventions disclosed herein it must be understood that it is not necessary to kill all anthrax spores, for example, (all other undesirable microbes in vegetative or spore state are included by reference) in an area to prevent a person in the area from acquiring anthrax. If a person receives only several hundred or a few thousand anthrax spores, the person is unlikely to become sick because the person's antibody system will likely defeat such a relatively small numbers of anthrax bacteria. It is generally only when the person's antibody immune system is overwhelmed with a large number of anthrax bacteria that people become sick and die. Therefore, it is hypothesized that the invented passive and inexpensive biocidal coatings, which will decrease the number of anthrax or other virulent microbes and spores in a given environment, will substantially lessen the likelihood that persons in that environment will acquire disease or become infected by the microbes listed.

The invented system is also useful for killing microbes which are in their vegetative state and for certain applications, the invented system calls for first spraying anthrax spores with nutrients to transform them into a vegetative state so they can be more completely and quickly and certainly killed. Further, active spore killing decontamination systems are disclosed. It is, however, hard-to-kill spores which create the most difficult problems. Use of the invention for total decontamination of an area is also disclosed.

It must be understood that for many of the described invented coatings, the intended useful result is “only” to reduce the number of virulent spores in a given environment so the human body can defeat the remaining spores. While the passive and inexpensive invented system may not kill all spores in the given environment, it is hypothesized that it may reduce the number of microbes (e.g. anthrax spores) to a sufficiently safe number. The invented system thus surprisingly incorporates the lack of a need for a 100% eradication of the spores into its design.

A useful feature of the invented biocidal coatings and treatments is that they are long-lasting, non-toxic, extremely effective in killing wide range of microbes and less deleterious to the environment than competitive biocidal systems.

To date, the invented calcium hydroxide coating has experimentally been shown to be effective against at least the following microbial species when applied to the coating based on calcium hydroxide onto treated surfaces: Pseudomonas aeruginosa; Staphylococcus aureus; Salmonella cholerasuis; Escherishia coli; Streptococcus faccialis; Klebsiella pneumonia; Legionella pneumophila; Alternaria alternata; Aspergillus spp.; Cladosporium spp.; Aureobasidium pullulans; Penicillium funicullatum; Stachybotras chartarum; influenza type A2 (Hong Kong); rhinovirus; rotavirus; adenovirus type 2; respiratory syncytial; hepatitis; polio virus type I; herpes virus hominis type I; parainfluenza virus type III. Those with skill in the art know that these results indicate effectiveness against other microbial species.

The invented calcium hydroxide based coating killed the tested microbes on contact and inhibited the growth and re-growth of microbes which come into contact with treated surfaces. The period of time to kill these microbial species is 5 to 15 minutes, depending on the class of microbes after they are applied to the surface of the calcium hydroxide based coating. Applying these spores to a solvent based calcium hydroxide based coating required 30 to 60 minutes of exposure, depending on the class of viruses and bacteria to completely destroy the organisms.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 and FIG. 1A show a proposed mode of action, so called BNA (Bi-Neutralizing Agent) for killing microbes on the calcium hydroxide based coated surface. In the first state, the BNA system is coated on a surface. The BNA system utilizes calcium hydroxide, a carbonated lime and a binder to produce special semi-permeable, selectively permeable membrane. This membrane, the core of BNA mode of action allows the water vapor and microbes to penetrate through the membrane and reach calcium hydroxide and therefore be killed. At the same time the membrane prevents the permeation of carbon dioxide and shields the calcium hydroxide from carbonation. The result is a biocidal surface that is lethal to microbes but harmless to humans and animals.

FIG. 2 shows a table of BNA laboratory test results having a column for the description of specific tests and a column with the corresponding results of the test.

FIG. 3 shows fungal growth on fruits and vegetables in boxes that are coated with a BNA coating and control box without any coating. The experiment consisted of two boxes, one was lined with BNA treated paper on both bottom and sides of box. The BNA treated box was covered by a non-BNA treated transparent Cover. The control box was not lined with BNA treated paper and was also covered by a non-BNA treated transparent cover. Panel A shows fruit and vegetable (e.g. orange, banana, apple, potato and plum) in a BNA lined box after three days; Panel B shows fruit and vegetable (e.g. orange, banana, potato, apple and plum) in a box without a BNA liner at three days; Panel C shows fruit and vegetable (e.g. orange, banana, apple, potato and plum) in a BNA lined box after seven days; Panel D shows fruit and vegetable (e.g. orange, banana, apple, potato and plum) in a box without a BNA liner at seven days. The conclusion of this study was that all fruit and vegetable in the box lined with BNA has shown drastic difference in its ability to prolong its original state showing far less signs of natural degradation over the box of fruit and vegetable without BNA lining that is showing the degradation of fruit and vegetable at the normal and expected rate. It is envisaged that organic products that are under the BNA protection would have far greater shelf-life and it would preserve its freshness for more then twice long then without the protection of BNA.

FIG. 4 shows Stachybotras Atra in BNA treated and Control untreated plates after 13 days at room temperature. The difference is obvious. Microbial growth was extensive on the control untreated plate while the BNA treated plate shown no fungal growth.

FIG. 5 shows Table 1. The inactivation of Poliovirus type 1 by exposure to test articles coated with BNA and control paint. Panel A shows results using BNA water based paint; Panel B shows results using BNA solvent based paint; and Panel C shows results using non-BNA control paint.

FIG. 6 shows Table 2. The inactivation of herpesvirus hominis type 1 one by exposure to test articles coated with BNA and control paint. Panel A shows results using BNA water based paint; Panel B shows results using BNA solvent based paint; and Panel C shows results using non-BNA control paint.

FIG. 7 shows Table 3. The inactivation of parainfluenza virus type 3 by exposure to test articles coated with BNA and control paint. Panel A shows results using BNA water based paint; Panel B shows results using BNA solvent based paint; and Panel C shows results using non-BNA control paint.

FIG. 8 shows a description of the different tests that were performed indicating that articles coated with BNA can eliminate salmonella and pseudomonas; staphylococcus, staphylococcus aureus and pseudomonas aeruginose, and the selected viruses.

FIG. 9 shows effectiveness of BNA treated objects against a variety of microorganisms.

FIG. 10 shows a calcium hydroxide factsheet.

### DETAILED DESCRIPTION OF PREFERRED EMBODIMENTS

While the inventions disclosed herein are directed to eliminating or substantially eliminating various microbes, including virulent spores and vegetative bacteria, from areas or surfaces, the inventions will be particularly described with reference to anthrax spores.

The term “Calcium Hydroxide,” as used herein refers to calcium hydroxide—Ca(OH)₂—a colorless crystal or white powder, is prepared by reacting calcium oxide (lime) with water. Calcium hydroxide is approved by the FDA for use in dozens of products and is used in pharmaceutical products, supplements, the dairy, sugar, gelatin, baking products and dental industries.

The term “Limewater,” as used herein refers to a water solution of calcium hydroxide, is used to treat acid burns and as an antacid. Calcium hydroxide, also known as hydrated lime or slaked lime, has been used for thousands of years as a germ-fighting agent in hospitals (especially before antibiotics). Its anti-microbial effectiveness is caused by increasing the pH, or alkalinity, to a level that is incomparable with the life of

microorganisms.

The term “Caliwel's,” also refers to Bi-Neutralizing Agent (“BNA”), which is safe and non-toxic to humans and animals. Normally, calcium hydroxide loses its effectiveness within days due to its rapid breakdown upon exposure to the air. Although not wanting to be bound by theory BNA works by harnessing the germ-killing power of calcium hydroxide in a micro-encapsulated formulation that prevents the normal breakdown of calcium hydroxide caused by carbon dioxide (“CO₂”). The BNA encapsulation process allows calcium hydroxide to maintain its alkalinizing power while protecting it from decomposition, thus allowing it to resist degradation and maintain an effective anti-microbial surface for years.

### Biocidal Coatings.

One aspect of the current invention includes a modified biocidal coating described in U.S. Pat. No. 6,231,650, titled “Biocidal Coating Composition,” issued to Mallow, et al. on May 15, 2001, (“the '650 Patent”). The '650 Patent described a hydrated lime paint or coating that can kill microbes and is safe for public use. The coating described in the '650 Patent can last longer than traditional white washes. Although not wanting to be bound by theory, the invention of the '650 Patent involved specific binders that could block the passage of carbon dioxide into the coating, preventing carbon dioxide from reacting with lime either in the coating itself, or in an underlying substrate. The binders were also surprisingly compatible with hydrated lime, and render the coating durable and adhesive upon drying.

The biocidal coating of this invention is non-toxic and maintains an alkalinity effective to kill microorganisms after one month exposure to 100% carbon dioxide, which would completely carbonate hydrated lime in a conventional lime coating in 1-2 days. As used herein, the term “one month of exposure to carbon dioxide” is defined to refer to exposure to 100% carbon dioxide for two days. In fact, the biocidal coatings maintain their biocidal activity for an indefinite period of time, even when aged in 100% carbon dioxide.

Specific ingredients in a biocidal coating are the binder and the lime. A biocidal coating preferably comprises the following materials in an appropriate solvent: hydrated lime; a binder; a humectant; and, a filler. Preferably, the coating further comprises pigment, a surfactant, and an antifoaming agent. In some embodiments, it may be desirable to add a plasticizer. The binders of the present invention exhibit unexpected carbon dioxide barrier properties, UV resistance, and extended biocidal activity. Additional components included components that reduce coagulation and phase separation, as described in the '732 Application. The coatings of the present invention are safe, easy to prepare, and contain low cost materials, making the coating easily affordable by medical, agricultural, industrial, and domestic users alike. Some preferred binders or components include: PolyOx.TM. (polyethylene oxide, Union Carbide); Hydroxy ethyl cellulose (HEC), obtained from Hercules, Inc.; Hydroxy propyl methyl cellulose (HPMC), obtained from Hercules, Inc.; Ethyl hydroxy ethyl cellulose (EHEC), obtained from Hercules, Inc.; Carboxy methyl hydroxyethyl cellulose (CMHEC), obtained from Hercules, Inc.; Carboxy methyl cellulose (CMC), obtained from Dow Chemical [Sufynol from Air-Products, Castament from DeGussa, Zonyl from Dupont, Special grade of lime from Mississippi Lime, Kronos from Cronos, Tylac from Dow Richhold, Nopco from Cognes, Foam Blast from Lubrizol, Culminal from Hercules, Tripropylene Glycol, Nytal from Vanderbuld]

The solvent or vehicle for the coating materials and binder may be aqueous or organic. The choice of solvent will depend upon the conditions that the coated item will encounter. For example, if the coating will be exposed to outdoor conditions, or if the coating will be exposed to repeated washings, then an organic solvent based binder may be preferred. The amount of solvent or vehicle used to make the coating is dependent upon the method of application desired. Preferably, the solvent or vehicle should be used in an amount sufficient to make the coating a spreadable fluid.

The binder of the biocidal composition should have the film properties of a carbon dioxide barrier, but should not act as a water vapor barrier. Carbon dioxide should be essentially blocked from reacting with the hydrated lime to form calcium carbonate. Water vapor should be able to permeate into the film to maintain a moisture content sufficient to (1) pull in and substantially encapsulate microorganisms and other biological contaminants, and (2) maintain hydroxyl ions in the lime in an ionized, highly alkaline state so that the lime will kill or otherwise render biological contaminants innocuous.

One of ordinary skill in the art will recognize that certain binders are chemically incompatible with hydrated lime, and should not be used in the present invention. Generally, these incompatible binders include most latex binders, especially pH sensitive lattices that result in coagulation and phase separation almost immediately upon blending with lime. Other incompatible binders are water soluble film forming binders such as certain polyalcohols, polyesters, proteins, and starch derived carbohydrates. Many of these binders are unstable in aqueous lime systems, and typically result in mixtures having viscosities that change steadily with time and that frequently even solidify. Suitable binders should offer chemical compatibility with hydrated lime, desired adhesive and coating properties, and the required barrier properties. Preferred binders are cellulose derivatives selected from the group consisting of an alkyl derivative, a hydroxyl derivative, and a carboxyl derivative. Most preferred binders are ethylcellulose and hydroxy propylmethyl cellulose.

The ratio of binder to lime in the coating is a feature of the coating. If the lime ratio is increased, the coating will have higher biocidal activity, but will be more friable. If the binder ratio is increased, the coating will be less friable, but the biocidal activity of the coating may decrease. Preferred formulas are given below for both a water base and an organic base coating. Regardless of the type of solvent, the amount of binder used should be sufficient to prevent carbonation of the lime and to maintain the biocidal activity of the coating for at least about “one month of exposure to carbon dioxide,” preferably enough binder to last for four years or more. Typically, the lime:binder ratio is in the range of from about 1:1 to about 3:1, preferably about 1.5:1.

Water-Base Coatings: Water soluble binders that are suitable for use in the present invention include, but are not limited to water soluble polyalkylene oxides and hydroxylated or carboxylated cellulose-derived polymers, including, but not limited to salts of cellulosic acids and carboxyalkyl-derivatives of cellulose, such as carboxyethylcellulose, carboxymethylcellulose, and carboxyhydroxycellulose. A preferred cellulose-derived polymer is hydroxy propylmethyl cellulose, most preferably Grade E5, available from Dow Chemical Co. A preferred polyalkylene oxide is Polyox.RTM. Grade N-80, which is available from Union Carbide. Water soluble polyethylene glycols, such as the CARBOWAX.TM. variety, available from Dow Chemical Co. and Union Carbide, also should operate as water soluble binders in the present invention; however, polyethylene glycols are not preferred binders.

The coating preferably should contain a humectant in order to draw water and water vapor into the coating and to stabilize the water content of the coating at a level sufficient to pull biological contaminants into the lime and to maintain the hydrated lime at an alkalinity effective to kill microorganisms. Suitable humectants for a water base coating include, but are not necessarily limited to, water soluble glycols, such as glycerol, polyethylene glycol and tripropylene glycol. A preferred humectant for water base coatings is glycerol.

Preferably, the coating should contain a plasticizer to facilitate processing and to increase the flexibility and toughness of the final product. Plasticizers are believed to “solvate” the polymer molecules in the coating. Suitable plasticizers for water base coatings also may serve as humectants, and include, but are not necessarily limited to, glycerol and polyols, such as polyethylene glycol and its derivatives. A preferred water-soluble plasticizer is glycerol. “Modifiers” also refers to surfactants, anti-foam agents, plasticizers, and humectants, combined.

An example of a preferred water base paint is as follows:

| Component | Range of Parts by Weight | (Preferred) |
|---|---|---|
| Binder | 10-30 | (20) |
| Hydrated Lime | 10-30 | (30) |
| Water | 60-150 | (100) |
| Surfactant | 0.5-2 | (1) |
| Titanium Oxide | 10-100 | (50) |
| Calcium Carbonate | 0-30 | (0) |
| Plasticizer (i.e., glycols) | 2-20 | (10) |
| Hydrophilic Thickener | 0-2 | (1) |
| Pigment | (as desired) | |
| Lime:Binder Ratio | 1:1 to 3:1 | (1.5:1) |
| Filler:Binder Ratio | 3.5:1 to 9.5:1 | (3.5:1) |

Organic Base Coatings. Suitable binders that are soluble in organic solvents include, but are not limited to, cellulose-derived polymers, including but not limited to: alkyl celluloses; cellulose ethers; esters of cellulose, such as cellulose acetate and cellulose butyrate. A preferred binder for use in organic solvents is ethylcellulose. Certain organically soluble polyethylene glycols also could be used as binders in organic base coatings; however, polyethylene glycols are not preferred.

The organic solvent system should have a controllable drying rate to avoid shrinkage or cracks. An organic base coating preferably should comprise between about 2-20 wt % humectant, preferably between about 5-15 wt % humectant. Suitable humectants include organically soluble polyalkylene glycols. A preferred humectant for an organic base coating is propylene glycol.

Suitable plasticizers for organic base coatings include, but are not necessarily limited to, non-volatile organic liquids and low-melting solids, such as phthalate, adipate, and sebacate esters, tricresyl phosphate, castor oil, etc. A preferred plasticizer for this organic base coating is propylene glycol, which also serves as a humectant.

A preferred solvent base paint is as follows:

| Component | Range of Parts by Weight | (Preferred) |
|---|---|---|
| Binder (ethylcellulose) | 10-30 | (20) |
| Hydrated Lime | 10-30 | (30) |
| Xylene | 50-200 | (100) |
| Toluene | 25-100 | (50) |
| Ethanol | 0-50 | (5) |
| Mineral Spirits | 0-50 | (5) |
| Titanium Oxide | 15-100 | (50) |
| Calcium Carbonate | 0-30 | (5) |
| Plasticizer | 0-10 | (5) |
| Hydrophobic Thickener | 2-20 | (10) |
| Pigment | (as desired) | |
| Lime:Binder Ratio | 1:1 to 3:1 | (1.5:1) |
| Filler:Binder Ratio | 3.5:1 to 11.5:1 | (3.5:1) |

With the addition of pigments (colorants), other than titanium oxide, or in addition to titanium oxide, the filler ratio will be at the higher end of this scale. In general, very small percentages (2-5 wt % of total recipe) of pigments (colorants) are typically used to provide the tone and shade desired.

Components that are useful in any solvent systems can be used. Some of the components of the coating may be used in either a water base or an organic base coating. For example, a filler is reflected in the above formulations, and preferably should be added to extend the coating and to provide inherent structure to the coating to reduce shrinkage and peeling, and to leave a continuous coating after the moisture evaporates. Suitable fillers for use with either solvent system include, but are not necessarily limited to, calcium carbonate, barium sulfates, silicates, glass spheres, hollow microspheres, silica flour, clays, talc, volcanic ash, fly ash, slag, titania, etc. A preferred filler is calcium carbonate.

Pigment or opacifier may be added, if desired, to opacify or add color to the coating. Suitable pigments/opacifiers for use with any of these solvent systems include, but are not necessarily limited to, calcium carbonate, titanium oxide, carbon black, chromium oxide, and iron oxide. Preferred opacifiers are calcium carbonate, which also acts as a filler, and titanium oxide, which also acts as a whitening agent. The pigment/opacifier preferably should comprise about 5-10 parts by weight of the coating.

Ionic and/or non-ionic surfactants of either the wetting agent, detergent, or emulsifier type also may be used to reduce the surface tension and to increase the efficiency of the coating in wetting its ingredients during blending. Suitable surfactants and detergents for use with any of these solvent systems include, but are not necessarily limited to, sodium alkyl and aryl sulfonates (anionic), alkyl phenol ethers of polyethylene glycol (non-ionic), and various cationic agents. Preferred surfactants are Dupanol ME, available from Dupont, Tergitol TMN and Tergitol 15S70, both of which are available from Union Carbide, or Triton X-100, available from Rohm & Haas.

An antifoaming or defoaming agent also may be added, if desired, for ease in processing. Suitable antifoaming agents for use with any of these solvent systems include, but are not necessarily limited to, sulfonated oils, organic phosphates, silicone fluids, dimethylpolysiloxanes, etc. Preferred antifoaming agents are Foam Blast 383 from Lubrizoil, Nopco NXZ fro Cognes, Dow Coming Antifoam Agent DB-31, SG-10, 1510US, 544 compound, DB110A, and similar antifoaming agents, all of which are commercially available from Dow Coming. A most preferred antifoaming agent is SG-10, available from Dow Coming.

Whether water base or organic base, the biocidal coating preferably should be applied to a thickness of between about 2-5 mils to assure long term biocidal activity of the lime. However, a thinner or thicker coating may be used.

In the paint industry, considerable latitude is taken to affect paints or coatings of varied textures, colors, and luster or flat appearance. Such practice can be applied to these basic recipes without altering their antimicrobial performance and their durability with respect to carbon dioxide resistance providing they do not transcend the critical lime to binder ratios and pigment to binder ratios expressed within the parenthetical ranges. The ranges given in the foregoing formulas allow for such latitude in the practice of preferred paint, texture, color, and application techniques.

Separate protective coatings incorporating a non-water soluble binder. Some concern exists that water base coatings or paints might be less durable than organic base coatings over the long term because of repeated washings, wipeings, etc. One way to prolong the life of substantially any hydrated lime coating, including a water base coating, is to provide the coating with a protective film comprising one of the non-water soluble, or organically soluble binders listed above.

A non-water soluble binder in a separate, protective film should provide substantially the same protection for the underlying lime coating as the protection afforded when the binder is incorporated directly into the lime coating. The binder in the protective film should prevent carbon dioxide from reacting with the lime in the underlying coating, and should allow moisture to permeate into the coating.

In a preferred embodiment, the protective film comprises between about 5-15 wt % of a non-water soluble cellulose-derived polymer dissolved in between about 85-95 wt % of an appropriate organic solvent, preferably a volatile organic solvent. The protective film preferably should be sprayed or otherwise deposited in a fine mist over the water-base coating to assure adequate coverage and protection of the coating.

Organic base coatings containing ethylcellulose as a binder were prepared using the following components:

| Component | Range of Parts by Weight |
|---|---|
| Ethylcellulose | about 5-20 |
| | (ETHOCEL .TM., obtained from Dow Chemical) |
| Toluene | about 30 |
| Xylene | about 50 |
| Ethanol | about 20 |
| Calcium Hydroxide | about 50 |
| Titanium Oxide | about 50 |
| Propylene Glycol | about 5-15 |

Other preferred water base coatings containing different binders [e.g. PolyOx.TM. (polyethylene oxide, Union Carbide); Hydroxy ethyl cellulose (HEC), obtained from Hercules, Inc.; Hydroxy propyl methyl cellulose (HPMC), obtained from Hercules, Inc.; Ethyl hydroxy ethyl cellulose (EHEC), obtained from Hercules, Inc.; Carboxy methyl hydroxyethyl cellulose (CMHEC), obtained from Hercules, Inc.; Carboxy methyl cellulose (CMC), obtained from Dow Chemical], and different modifiers [e.g. surfactants, anti-foam agents, plasticizers, and humectants, combined] prepared using the following ranges of components:

| Component | Range of Parts by Weight |
|---|---|
| Binder | 5, 10, and 15 |
| Water | 100 |
| Calcium Hydroxide | 10-50 |
| Calcium Carbonate | 50-150 |
| Titanium Oxide | 0-15 |
| Modifiers | 5-15 |

The coatings were spread onto various substrates, including concrete, Plaster of Paris, aluminum, stainless steel, plastics, etc., to a thickness of between about 2-5 mil, typically about 3 mil. The coatings exhibited good adhesion.

### EXAMPLES

The following examples are provided to further illustrate this invention and the manner in which it may be carried out. It will be understood, however, that the specific details given in the examples have been chosen for purposes of illustration only and not be construed as limiting the invention. Thus, persons of ordinary skill in the art will recognize that many modifications may be made to the present invention without departing from the spirit and scope of the present invention.

### Example 1

### Addition of Humectant

As described above and it the '509 Patent, the '650 Patent, the '638 Patent, and the '732 Application, calcium hydroxide has a biocidal activity if its high alkalinity can be communicated to bacteria, mold, fungus, etc. To provide an effective coating to accomplish this with a long duration, most of the coatings described herein both (1) permit aqueous communication of hydroxide ions or communication of the effect of the alkalinity of hydroxide ions from calcium hydroxide in the coating to organisms on the coating's surface and (2) prevent carbon dioxide in the atmosphere from contacting with the calcium hydroxide, which would convert the calcium hydroxide via carbonation into useless calcium carbonate. Restated, to provide a long-lasting antimicrobial effect, the invention provides calcium hydroxide which is in substantial aqueous communication with the surface of a coating but is not in substantial gaseous communication with the surface of the coating. While glycerin is used for this purpose, non-glycerin cellulose coatings which have a similar action may be usefully used.

The protective layer in the invented coatings, typically cellulose as described herein, prolong the life of calcium hydroxide in the invented calcium hydroxide coatings for much longer than if the calcium hydroxide was in contact with ambient carbon dioxide, at least thirty days. Based on test data, the invention is believed to keep calcium hydroxide active in both latex and solvent based coating formulations for at least one year and, further, beyond six years. But for the carbon dioxide resistant layer, the calcium hydroxide would normally rapidly degrade in ambient air within a few weeks due to carbonation by atmospheric carbon dioxide, thus causing it to lose its biocidal properties.

Microbes in their vegetative state typically contain sufficient moisture and have a sufficiently permeable outer membrane to communicate calcium hydroxide's alkalinity to within the organism. If small organisms in their vegetative state are placed in contact with calcium hydroxide they are killed. Spores, however, often do not contain sufficient moisture or have a sufficiently permeable out membrane to communicate calcium hydroxide's alkalinity to within the spore. An additional source of moisture must be supplied to the contact surface between the calcium hydroxide and the spore for calcium hydroxide to kill spores.

While conversion of spores into their vegetative state is discussed herein, the invention also contemplates merely hydrating spores as a step in killing them. Hydration is needed to permit communication of the calcium hydroxide's alkalinity to within the spore with killing effect. While converting spores into a vegetative state is useful because microbes are easier to kill in their vegetative state, doing so is not necessary for the invention to work. Mere hydration of the spore rather than conversion into its vegetative state is often all that is needed for the invention to work as disclosed. The invention makes use of this insight in the disclosed coatings, compositions and methods. In the discussion herein, reference to providing moisture to convert the target microbe into a vegetative state includes the intermediate step of hydrating the microbal spore and may end with that step in the appropriate circumstances.

As described herein, the invented biocidal coatings may be of various compositions, depending upon their desired use. For wall paint, the biocidal coating is typically comprised of a polymerized liquid film-forming matrix. The coatings which include, in some compositions, a small amount of hydrophilic thickener or humectant as an antifreezing agent. In the instant invention, the intended result of killing anthrax spores surprisingly inspires an increase in the amount of humectant for the purpose of supplying the moisture needed to communicate the effect of calcium hydroxide alkalinity to within the spores. The portion of humectant in the newly invented coatings may be expanded from the about five percent of the coating to over fifteen percent. A most useful range for humectant in coatings intended to be effective to kill dry anthrax spores runs from over fifteen percent to about twenty-five percent of the coating by volume. Lesser amounts of humectant will provide for a lesser, but still useful and still unexpected spore killing ability. The coating will retain spore killing ability for at least thirty days and preferably for at least one year.

The humectant selected is of a type and quantity sufficient to draw moisture from the air and concentrate it in the biocidal coating or retain sufficient moisture from original application of the coating so when a spore, such as an anthrax spore, comes into contact with the biocidal coating, that the alkalinity of the calcium hydroxide in the coating is communicated to the spore via the moisture provided by the humectant. In particular, if spore killing ability is desired, a humectant of a sufficient type and a sufficient quantity needed to deliver a sufficient amount of moisture at the point of contact between the spore and the calcium hydroxide is needed for the calcium hydroxide to have a killing affect on the spore. The particular effective amount of humectant for any given coating can be determined by routine experimentation. Further, invention combinations are described herein disclosing misting and humidifiers or forms of washing, etc. to add moisture, each of which will have an effect on the desired amount of humectant.

A preferable humectant for the invented calcium hydroxide coating is 15% glycerin by weight. Other useful humectants are: vegetable oils, ammonium chloride, calcium chloride, sodium sulfate, aluminum sulfate, sodium acetate, and hydrous salts. Humectants like glycerin and ethylene glycol are not compatible with the hydrocarbon binder of the invented calcium hydroxide coating. Suitable humectants for an organic base coating include organically soluble polyalkylene glycols, among others. Propylene glycol and polypropylene glycol are useful humectants, but are not as aggressive as glycerin. The design of humectants per se is well-known, particularly to those of ordinary skill in the cosmetic industry. The cosmetic industry often uses humectants to maintain a high level of moisture on the surface of the skin. The use of humectants to facilitate the killing effect of calcium hydroxide, however, is surprising.

It will be appreciated by those with skill in the art that, in addition to a latex carrier, volatile organic solvent-based paints or water soluble cellulose-based paints may be used to create an antimicrobial surface using the teachings of this application. Further, those with skill in the art and the periodic table will understand from this disclosure that other sources of alkalinity may be used in place of calcium hydroxide to produce the desired source of microbe killing alkalinity required by the inventions.

In some of the biocidal coatings described herein an additional amount of humectant is unnecessary. For example, gloves used by meat packers or food processors will typically accumulate enough moisture from the meat, produce, or food being handled so that the alkalinity of the calcium hydroxide may be communicated to spores with killing effect without a humectant. The invention makes use of this insight. Such biocidal coatings will be discussed below.

Further, in some environments, enough moisture will be drawn from the air to the coating, retained in the coating from original laying on of the coating or present in the air as applied to the outer surface of the coating that the alkalinity of the calcium hydroxide may be communicated to the spore without the necessity of special humectants. Such biocidal coatings will be discussed below.

### Example 2

### Horizontal or Working Surfaces.

The calcium hydroxide/cellulose/latex paint of the '509 Patent, the '650 Patent, the '638 Patent, and the '732 Application, may be modified as taught herein and put upon horizontal surfaces in mailrooms, post offices, etc., to kill anthrax spores. This is a new and surprising use for the invented biocidal coatings. The formulations for biocidal paint in the '509 Patent, the '650 Patent, the '638 Patent, and the '732 Application, are typically for walls and vertical surfaces and are not specially designed to kill anthrax spores. First, as described above, to specially design the invented coating to be most effective in killing anthrax spores, an appropriate amount of humectant is added to the biocidal coating to supply the needed moisture. Second, to add durability to horizontal or working surfaces, the latex content of the biocidal paint or coating will preferably be increased from the about 25% of the '509 Patent, the '650 Patent, the '638 Patent, and the '732 Application, to an amount within the range of approximately 35% to approximately 40%.

Over time, a working surface may become impregnated with an outer layer of grease, dirt, grime, etc, due to work being performed on it. The invented biocidal coatings with extra latex and extra calcium hydroxide are designed to be durable and washable without losing a substantial amount of effectiveness for at least thirty days and preferably at least one year, as long as the coatings are not kept in continuous flushing contact with water. Further, when the surface becomes dirty, the surface may be washed with a fluid that contains additional calcium hydroxide and which is effective to somewhat rejuvenate the anthrax-killing and general antimicrobial properties of the surface.

It is hypothesized that the additional humectant may be lessened or omitted if moisture is supplied by other means as needed, such as spraying it or wiping it with a wet rag periodically or in the presence of high humidity.

Additional types and amounts of resins and latexes as will be appreciated by those with skill in the art will be added to the paint to make it sufficiently hard and durable to provide a horizontal working surface while yet including a sufficient amount of calcium hydroxide in communication with the coating's outer surface to provide a sufficient amount of alkalinity on the outer surface to kill spores.

The disclosed antimicrobial inventions are applicable to any surface, be it horizontal, vertical, the external or internal surfaces of machines, etc. The inner and outer surfaces of machines such as mail sorting and handling equipment in post offices and other object moving facilities may have the invented coating applied to it. Any of the coatings and treatments described herein may be combined with static electricity for the purpose of attracting and killing microbes. Additional surfaces may be added to such equipment and charged with static electricity for the purpose of attracting and killing spores attached to the mail or other object being handled. Equipment may be added which deliberately subjects items to (1) mild abrasion against a coated surface, (2) shaking over a coated surface, (3) moving air toward a coated surface, or (4) static electricity drawing microbes toward a coated surface. This equipment could be tested periodically to determine if target microbes have been caught. Some items, such as the keys of computer keyboards, handles, floor surfaces, telephones, toilet seats and other high use or abraded items may be comprised of materials which incorporate the invention into the item itself. Special floor mats or rugs which are infused with the invented coating may be used in high risk areas to catch and kill microbes. These items may be charged with static electricity to attract microbes and kill them.

### Example 3

### Biocidal Containers.

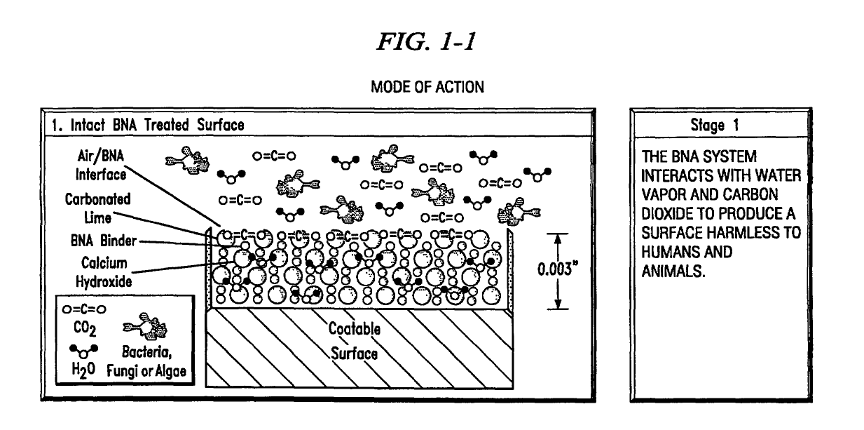

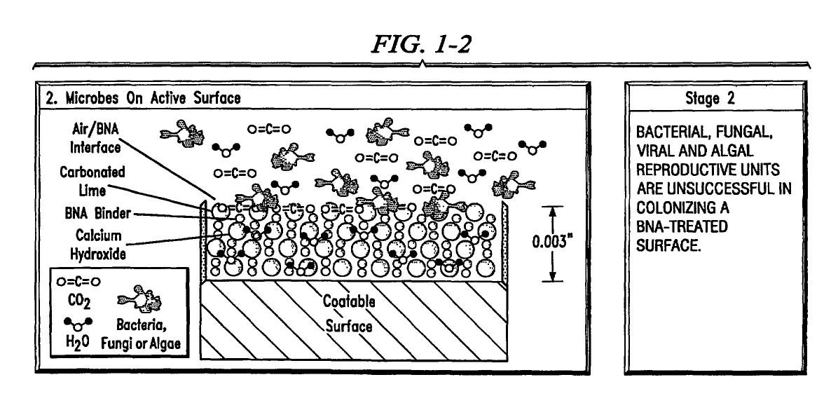

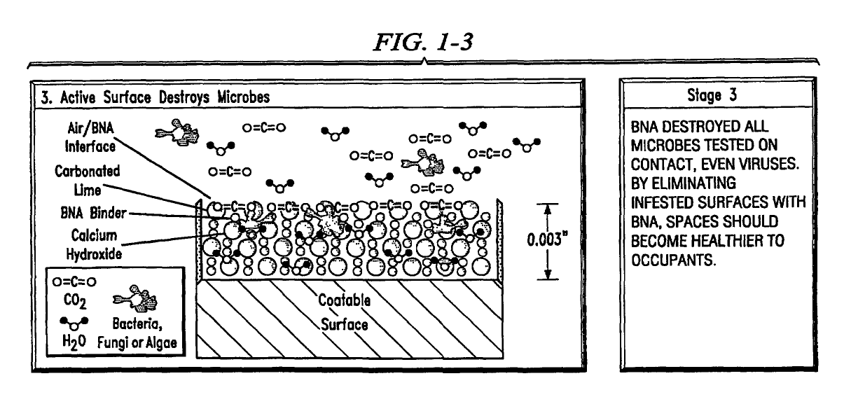

Bacteria and Fungi. Although not wanting to be bound by theory, a proposed mode of action for killing bacteria on the calcium hydroxide coated surface is shown in FIG. 1. In the first state, a biocidal coating called a BNA system is coated on a surface. The BNA system utilizes calcium hydroxide, a carbonated lime and a BNA binder. Generally, the BNA system interacts with water vapor and carbon dioxide to produce a surface harmless to humans and animals. Bacterial, fungal, viral and algal reproductive units are unsuccessful in colonizing a BNA treated surface. As a result, a BNA system can destroy all microbes tested on contact, even viruses. By eliminating infested surfaces with a BNA, spaces should become healthier to occupants.

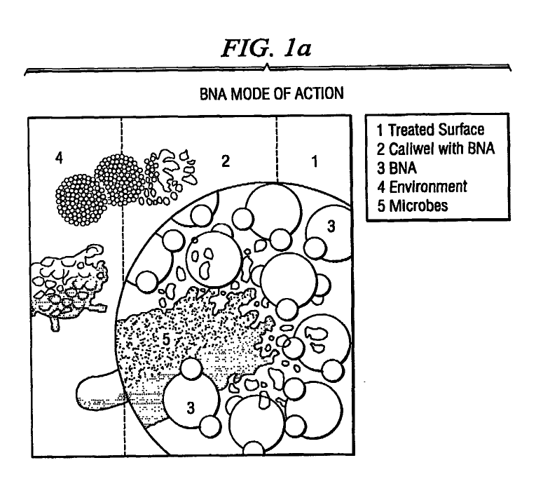

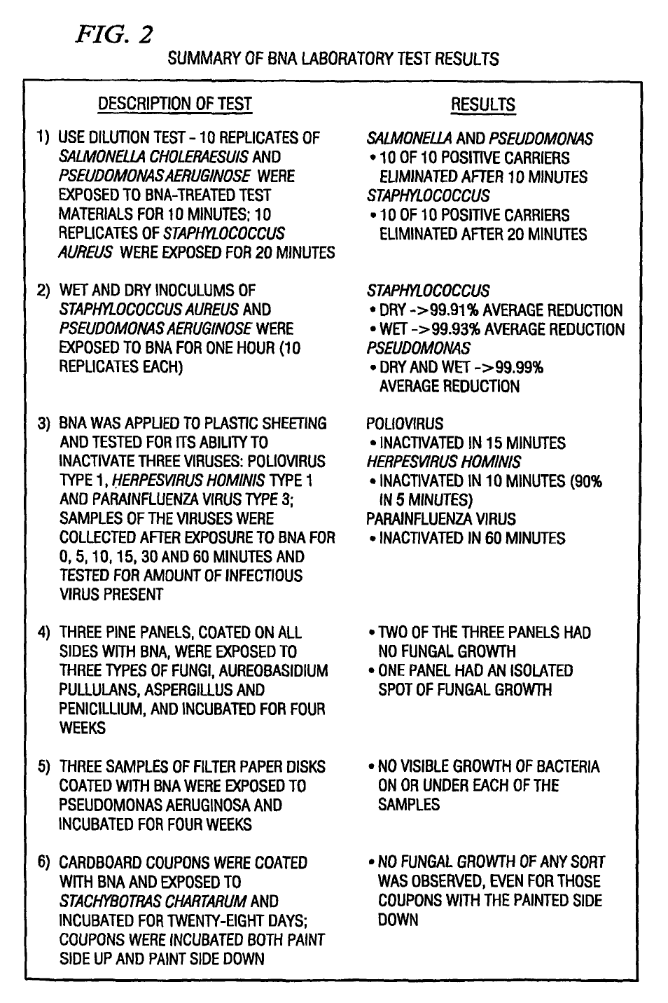

A table of biocidal coating BNA laboratory test results are shown in FIG. 2. The table of FIG. 2 contains a column for the description of specific tests and a column with the corresponding results of the test.

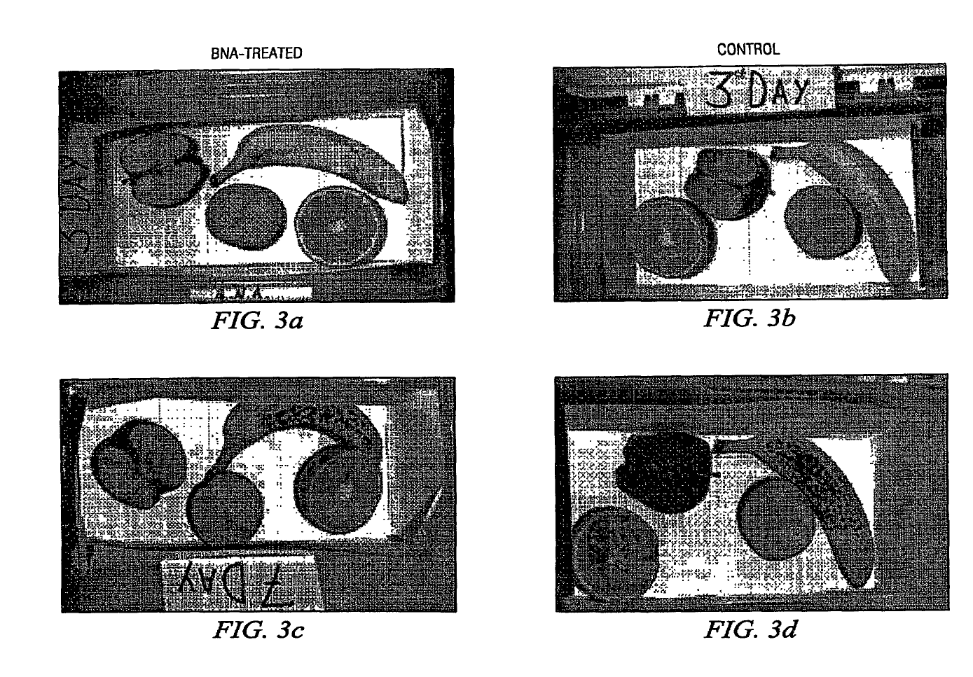

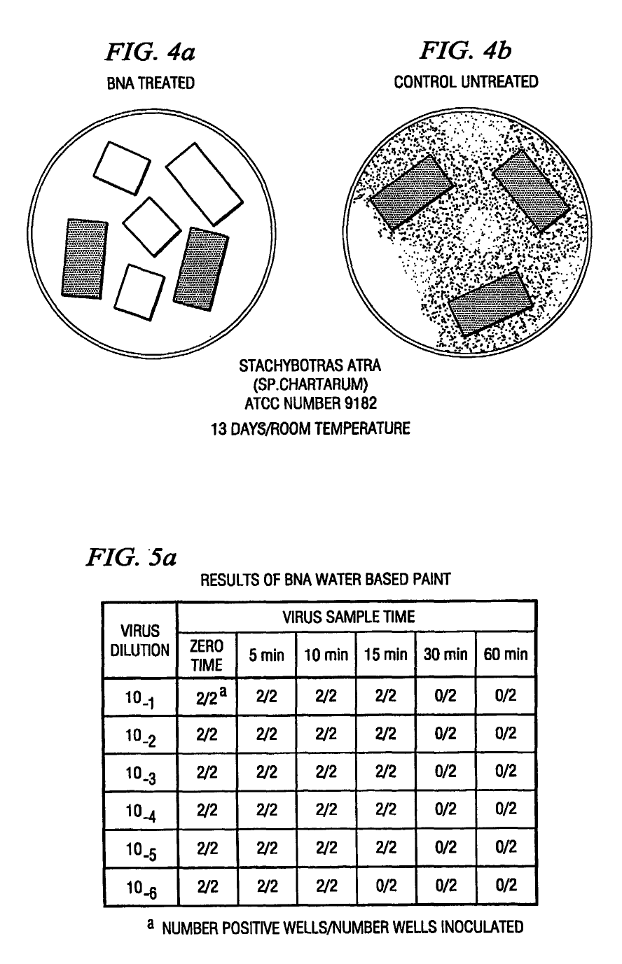

As shown in, FIG. 3 shows fungal growth on fruits and vegetables in boxes that are coated with a BNA coating and control box without any coating. The experiment consisted of two boxes, one was lined with BNA treated paper on both bottom and sides of box. The BNA treated box was covered by a non-BNA treated transparent Cover. The control box was not lined with BNA treated paper and was also covered by a non-BNA treated transparent cover. Panel A shows fruit and vegetable (e.g. orange, banana, apple, potato and plum) in a BNA lined box after three days; Panel B shows fruit and vegetable (e.g. orange, banana, potato, apple and plum) in a box without a BNA liner at three days; Panel C shows fruit and vegetable (e.g. orange, banana, apple, potato and plum) in a BNA lined box after seven days; Panel D shows fruit and vegetable (e.g. orange, banana, apple, potato and plum) in a box without a BNA liner at seven days. The conclusion of this study was that all fruit and vegetable in the box lined with BNA has shown drastic difference in its ability to prolong its original state showing far less signs of natural degradation over the box of fruit and vegetable without BNA lining that is showing the degradation of fruit and vegetable at the normal and expected rate. It is envisaged that organic products that are under the BNA protection would have far greater shelf-life and it would preserve its freshness for more then twice long then without the protection of BNA.

### Example 4

### Biocidal Gloves.

Postal workers, medical workers, workers in packing plants, food processing plants, grocery stores, etc., would benefit from inexpensive nontoxic antimicrobial gloves. Postal workers, doctors, nurses, other health care workers, etc., already use disposable latex gloves. By impregnating these gloves with sufficient calcium hydroxide according to the invention, the gloves may both kill anthrax spores and have general antimicrobial activity. The invented biocidal latex gloves can be made by generally deleting the various paint specific components, such as pigments, fillers, etc., from the previously described biocidal latex paint formulations and adding plasticizers, rubberizing agents, and the like as is known to those skilled in the art. In one embodiment, cellulose is not needed to create the described protective coating against carbonation of the calcium hydroxide (as is necessary in long lived biocidal paint) if the gloves are intended to be disposable gloves, i.e., intended to have a life within carbonation parameters. Such biocidal calcium hydroxide impregnated disposable latex gloves may be made available at the work place in airproof containers to prevent carbonation before use. Such pre-packing is common with disposable latex gloves in the medical field. The worker opens the airproof container, takes out the gloves, puts on the gloves, uses the gloves during the worker's shift and disposes of the gloves at the end of the shift. The life span of such gloves is sufficiently short that carbon dioxide in the ambient environment will not have sufficient time to convert enough of the calcium hydroxide in the gloves into calcium carbonate to materially reduce the gloves' biocidal effectiveness in one 12-hour period.

This is in contrast to the invented biocidal paint, which needs a cellulose binder to protect the calcium hydroxide from carbon dioxide for an extended period, at least in excess of thirty days, and preferably in excess of six years. Thus, in the simplest such disposable gloves, the latex itself is the only binder. The gloves would be about ninety to about ninety-five percent latex and about five to about ten percent calcium hydroxide. The synthetic or natural rubber composition, likely including solvents and rubberizing components, remains sufficiently flexible to comprise a useful biocidal disposable glove in spite of the addition of calcium hydroxide. Plasticizers may be added to the latex to make sufficiently flexible disposable gloves. An example composition of such a disposable glove would be about 100 parts latex liquid, about 25 parts calcium hydroxide powder dispersed therein, together with appropriate amounts of plasticizers. Such gloves contain about 33⅓% calcium hydroxide based on a dry solid measurement.

This produces flexible latex gloves which have antimicrobial and spore killing activity in the presence of moisture. If the working environment does not provide sufficient moisture, then an appropriate amount of humectant is added to the composition of the disposable latex gloves for it to have the desired antimicrobial effect. For other types of gloves which are intended to have a long lasting effectiveness, a carbon dioxide barrier, such as cellulose, must be included as a component. This will affect the ratios of the other ingredients.

It is understood that if the alkaline nature of a single layer glove, which layer is impregnated with hydrated calcium hydroxide, is difficult for the person to tolerate when it touches the person's skin, that multiple layers may be used in the glove to keep the alkalinity from the person's skin. An inner layer may be added to the latex gloves which inner layer is comprised of latex without calcium hydroxide, if the alkalinity of a calcium hydroxide layer proves uncomfortable or irritating to the wearer. For example, an outer layer may have a large quantity of hydrated calcium hydroxide while an inner layer completely lacks the hydrated calcium hydroxide or has a much smaller amount of hydrated calcium hydroxide. Such layers maximize the biocidal effect of the outer layer while minimizing the adverse effect on skin caused by the inner layer.

### Example 5

### Biocidal Working Clothes.

Biocidal aprons, pants, shirts and other clothing would be useful for postal workers, medical workers, food processing workers, meat packers, etc. There is an unmet need for such clothing for these workers which is effective to kill anthrax and other virulent spores.

It will be appreciated by those with skill in the art that, in contrast with the invented coating for use on a horizontal surface, the biocidal latex used in disposable gloves or on clothing will have such solvents, rubberizing agents, or other ingredients needed to make the gloves or clothing sufficiently flexible for their intended purpose. Cost considerations may militate toward the use of multi-layered coatings. The outer layer of such multi-layered coatings would contain the preferable amount of hydrated calcium hydroxide for biocidal purposes. Inner layers may provide strength, flexibility, etc., and serve as a substrates for the outer layer.

A biocidal layer can be applied to clothing by any known technique, such as spraying, layering, and the like. The clothes may be disposable, producing the various options discussed elsewhere herein. The clothes may be comprised entirely of the biocidal composition as discussed elsewhere herein. Those with skill in the art will understand that the amounts of latex, flexible elements, humectant, and calcium hydroxide may be altered in their amounts and ratios until desirable mechanical integrity and biocidal activity are achieved. Long term effectiveness may be had by adding a carbonation barrier as discussed herein. The invented coating binds well to fabrics and is very flexible and touch. Antimicrobial and other qualities may be determined by routine testing by those with skill in the art.

### Example 6

### Biocidal Filters and Baffles.

Filters and baffles may be usefully impregnated and coated with the invented biocidal coating. Such filters may have permeable or rough substrates which incorporate the invented biocidal coating on their surface or throughout their matrix, such as air filters comprised of thin strands of cellulose or fiberglass or micromeshes. While such filters are applicable to commercial HVAC systems, the average homeowner could also install such filters in his or her air conditioning system which filters are treated with the invented calcium hydroxide coating to make the home safer from airborne microbes and spores. Baffles may be used to circulate spores entrained in gases such as air and to increase the interaction of circulating spores with the biocidal calcium hydroxide, both by putting the biocidal coating on the baffles and due to the baffles directing the spores against other biocidal coatings. Static electricity may be used to attract airborne microbes to the coating.

If a filter is intended for long-term use, for example, in a building's HVAC system, the biocidal coating in the filter will need a cellulose or cellulose type binder described herein to protect the calcium hydroxide from carbon dioxide. On the other hand, if a gas mask filter, for example, is intended to have only short term effectiveness, the biocidal coating will not need a cellulose or cellulose type protective binder.

### Example 7

### Biocidal HVAC Systems.

One of ordinary skill in the art with recognize that heating, ventilation, and air conditioning (HVAC) system components or interior surfaces of lined and unlined duct systems experience fungal and bacterial growth. Additionally, duct cleaning alone may not provide adequate protection from re-growth of fungal or bacterial contamination on fiberglass duct liner (FGDL). Current recommendations for remediation of fungi or bacterial contaminated duct materials specify complete removal of the materials. However removal of contaminated materials can be extremely expensive. Therefore, a common practice in the duct-cleaning industry is the post cleaning use of antimicrobial surface coatings with the implication that they may contain or limit re-growth of fungus or bacteria in the HVAC systems. Little information is available on the efficacy of these treatments for more dangerous forms of pathogens such as anthrax spores.

Persons have contracted anthrax due to anthrax spores being transmitted through building heating, ventilation and air conditioning (HVAC) system components. It is hypothesized that coating all or at least an effective portion of HVAC conduits with the invented biocidal coating will inexpensively prevent spores from spreading between areas of a building through its HVAC system.

HVAC conduits may be retrofitted to kill spores by spraying or otherwise coating their interior with the invented biocidal coating to create a passive, long lasting and inexpensive anthrax-killing system. A typical biocidal coating inside a conduit will have a different composition than the previously described biocidal wall paint. It will not need pigments, it will not need to be aesthetically pleasing. The primary concern in creating such a biocidal coating is to kill anthrax spores which light on surfaces in the conduit. Thus, the coating may be comprised of inexpensive filer and rough filler, etc. It may be very porous. It should be stable enough to stick onto the inner surface of the HVAC conduit without flaking or powdering to cause debris which is blown into the building's rooms. All possible measures may be taken to inexpensively create surface area for contact and killing of spores and break up laminar air flow in the conduit to maximize the number of spores that contact a painted surface. The invented biocidal coating applied to the interior of HVAC conduits will be with lower cost materials than the described biocidal wall paint.

Laminar flow in a HVAC conduit is preferably disrupted to better ensure that as many entrained spores in the circulating air as possible contact the biocidal coating. Baffles may be added to the conduit to lessen laminar flow by increasing turbulence of the flowing air. The baffles themselves may be coated with the biocidal coating. The majority of the interior of HVAC conduits are comprised of metal. The composition of the biocidal coating is adjusted to most effectively and yet most cheaply attach to metal surfaces where the conduit is metal. Materials suitable for adhering a coating to a metal are well known to those in the coating art.

It will be appreciated by those with skill in the art that, in addition to being used in new construction, the invented biocidal coating may be usefully used to retrofit current HVAC systems by simply removing the HVAC entrance and exit grills and spraying, foaming, or otherwise forcing a proper mixture of calcium hydroxide, cellulose, and humectant, together with a chosen binder such as, latex, through the conduit. It is hypothesized that forcing a biocidal foam through a HVAC conduit is an effective way to inexpensively coat the entirety of the interior surfaces with a biocidal coating. The treatment may be repeated periodically as needed. Upon reattachment of the grills, this provides a method and materials for retrofitting the existing HVAC system in a building into a spore-killing system which is invisible, passive, long lasting, and inexpensive. One of ordinary skill in the art would understand that the current invention would also be a useful coating in connection with other HVAC system components including: Return Air Chamber; Fresh Air Chamber Mixing Box Air Chamber; Coils Coil Compartment; Fan Housing; Condensate Pan; Humidifier; Dehumidifier; Spray Eliminator; Filters Housing; Louvers; HVAC Supply Return Ductwork; Dampers Turning Vanes; Exhaust Ducts; Dampers; Fans Fan Housings; and Wall Floor Registers Ceiling Diffusers

### Example 8

### Variations in Surface Roughness and Porosity.

Prior biocidal coatings and paints are designed to be washable and attractive. They are not designed to have high porosity, or a greater surface area or to be inexpensive as primary goals. It is useful, however, for surfaces which are not visible or which do not need to be smooth and washable, for the biocidal layer to be rougher and more porous than the described invented biocidal wall paint because greater roughness and porosity increase the coating's killing surface area and decrease its cost.

It is sometimes useful to increase the roughness of the calcium hydroxide surface of the biocidal coating. This increases the surface area capable of interacting with and biologically deactivating spores. To accomplish this relatively large inert or active fragments are left in the calcium hydroxide mixture that is applied within the conduit or other surface. After the coating dries, the roughness caused by these fragments provides both a larger killing surface area and a measure of turbulence in the air flowing over the coating to break up laminar flow to further increase contact of spores with the biocidal layer.

Simultaneously, the outer binding layer of the invented biocidal coating may be designed to increase antimicrobial activity without the restraints of washability and attractiveness or merely to be less expensive by deleting components other than cellouse and calcium hydroxide. A typical use of such a less expensive, rougher, more porous biocidal layer is in HVAC conduits or filters.

### Example 9

### Combination of Antimicrobial Agents.

The effectiveness of the invented biocidal system's ability to kill anthrax spores is likely dependent on the amount of time the anthrax spore spends in contact with the biocidal coating's surface. Microencapsulation of other antimicrobial and anthrax killing systems such as hydrogen peroxide, colloidal silver, etc., in the biocidal system may be useful to kill the impacting organisms. Although not wanting to be bound by theory, different spore killing systems can be used in combination with the invented biocidal system, for example the addition of hydrogen peroxide plus colloidal silver, etc., or some combination thereof, will kill more anthrax spores or other microbes in a lesser period of time. Speeding killing action may be important since the time period of spore contact with the killing surface may be limited. Combining killing systems may be particularly useful on surfaces such as the interior ofconduits where appearance is not a consideration.

### Example 10

### Improved Storage of Food.

The decay of food products may be delayed by wrapping them in a wrapping having the invented lime based biocidal coating. Attached as exhibits are color photos which illustrate the beneficial result of using the invented calcium hydroxide-based biocidal coating to delay the decay of produce. The produce shown in the photos was sealed in containers, the inner surface of one set of containers was coated with the invented lime biocidal coating; the inner surface of the control containers was untreated. That the produce in the treated containers is less decayed versus the control untreated container is readily apparent. Lime used in a wrapping in this way does not have any harmful effects on the produce or on human health. The use of such packaging to delay the deterioration of food products meets a long recognized and long felt need. The closer the invented biocidal packaging is to the food product, the better the effect. It is hypothesized that this is because the alkaline-killing surface is able to contact a greater portion of the airborne bacteria and other decay-causing agents present in the area near the produce. In one embodiment, a sufficient amount of calcium hydroxide is incorporated into the plastic coating which is directly applied to the food product.

Painting the inside of a refrigerator, freezer, food pantry or other food storage container with the invented biocidal coating will reduce the bacteria count within those enclosed spaces for an extended period of time. The rubber or other flexible seals on refrigerator and freezer doors and other flexible seals at the edges of doors, windows and other edges of closeable openings particularly need an antimicrobial treatment. Often such seals accumulate microbes due to the moisture and nutrients that collect there. The invented lime-based killing system is particularly useful for such seals. The calcium hydroxide can either be coated on the seal or manufactured integrally into it. In either case, the invention's composition provides a seal which is nontoxic to animals and is flexible, inexpensive and long lasting.

### Example 11

### Immediate Decontamination.

A current method of killing anthrax spores in a contaminated building is to fumigate the building with the very toxic gas chloride dioxide. As discussed, attempting to kill dry spores, such as Anthrax spores with a dry killing agent, such as chloride dioxide gas, uses an inappropriate means to attack the microbe in its most defensible state. Further, the pathogenic microbes to be killed may have already colonized the area, forming clumps or biofilms. A decontaminating gas, and even many toxic fluids, may kill the outer layers of microbes in such colonies but leave a protected inner group of microbes alive. The surviving microbes, through natural selection and being protected by the outer layer of hard, dead microbes, may be harder to kill if the same decontamination method is used again. Thus, existing decontamination methods are expensive, use toxic materials, use an inappropriate method to attack the microbe in its most defensible state, and must be completely evacuated from the decontaminated area, leaving the area defenseless against a future contamination event or a spread of contamination from any surviving microbes.

Under some circumstances it will be more desirable to decontaminate an area by spraying a calcium hydroxide-containing foam or other carrier into the area, including its floors, walls, furniture, etc. Because the invented decontaminating mixture is water based, it causes spores it contacts to go into a vegetative state where they are easier for the alkalinity of the calcium hydroxide to kill. Such decontaminating foam or other carrier may be forced through HVAC conduits and then left in the HVAC conduits to permanently decontaminate them. In other cases, a spray or mist comprised of latex or water stabilized calcium hydroxide may be also be blown through an area to kill microbes and prevent disease.

A foam or other carrier comprised primarily of water and appropriate amounts of calcium hydroxide and a foaming agent will usefully kill spores with which it comes into contact. Because the calcium hydroxide treatment works by communicating its killing alkinity, it is effective through a microbial colony's layers and biofilms to kill all of the microbes in the colony, including the innermost microbes. This is in contrast to some current decontamination methods which merely kill outer microbial layers of a colony leaving the inner protected microbes to reinfest the area. The decontaminating calcium hydroxide may be applied in the area to be decontaminated in the form of foam, liquid, fog, spray, mist, gel, etc. Additional benefits are that the invented calcium hydroxide decontamination treatment, in whatever formulation it is delivered, is nontoxic and non-corrosive.

High expansion foaming agents get a 10,000 to 1 ratio of volume to liquid. Since calcium hydroxide is cationic, a nonionic surfactant or foaming agent is preferred. The water in the foam provides a sufficiently effective barrier against atmospheric carbon dioxide causing decarbonation of the calcium hydroxide to extend its biocidal effect for the period needed for the decontamination of a building or other given environment. The foam would be preferably about 10% calcium hydroxide by weight. This would be enough calcium hydroxide to cover almost the entire surface of the bubble. The bubbles are about 3 to about 5 microns or smaller. A preferable amount of surfactant would be about 2.5% by weight. The surfactant may be about two to about four percent by weight. These amounts can be varied somewhat by experimentation by those with skill in the art. Polypropylene glycol is a preferable humectant and cellulose, a preferable binder. Both are water soluble and hydrocarbon soluble. Other workable compositions will be determined by routine experimentation by those with skill in the art.

A room decontaminated with chloride dioxide gas (ClO₂) typically needs to have the very toxic gas evacuated through a neutralizing filter of water. With the invented decontaminating mixture, the remaining powder after the decontaminating mixture is dried is merely nontoxic cellulose/calcium hydroxide powder. After the room is dried, the cellulose/calcium hydroxide powder can be easily vacuumed without risk to the environment or to the decontaminating personnel.

After chloride dioxide gas is fully flushed from the decontaminated room, there is no biocidal agent remaining. The invented decontamination system leaves small amounts of calcium hydroxide in cracks and crevices which calcium hydroxide is protected from carbonation by the small amount of cellulose included in the decontaminating foam, fluid, mist, etc. Thus, an environment which is decontaminated with the invented system is not only safe, it is safer with respect to future spores than before it was contaminated. This provides a real benefit and is a substantial inducement to frightened persons to return to the previously contaminated environment.

Lime produces a saturated solution of about 0.2 grams per 100 cc which has sufficient alkalinity (pH 12.4) to kill the most resistant spores and organisms. As an alternative to chlorine dioxide, which is a very poisonous gas and requires extensive decontamination, spraying an aqueous mist of the saturated supernatant of lime water (that which rises freely to the top allowing the solids to separate to the bottom containing 0.185 grams per 100 cc) will kill resistant spores and organisms. A clear, saturated solution of lime water (pH 12.454) may be applied to surfaces to kill very resistant spores and organisms. This leaves a minimal residue of calcium hydroxide on surfaces which can be wiped later. This same solution can be used to wipe down cabinets and fixtures that might otherwise not be conducive to being misted with water. A rag dampened with the solution may also clean surfaces. Adding a cellulose component will provide a long lasting antimicrobial residue.

A substantial problem exists concerning remediating residential and commercial structures which are contaminated with microorganisms such as mold and fungus. The coatings, materials and treatments described herein are useful for both preventing such problems and remediating such structures.

### Example 12

### Long Lasting Decontamination.

An additional method of decontaminating an area is to paint the invented calcium hydroxide coating on the possibly contaminated surfaces. This may range from regularly scheduled repainting of hospital and nursing home rooms to emergency decontamination of a known contaminated area. Painting or otherwise coating an area with the invented coating, decontaminates the area. The invented calcium hydroxide coating has both sufficient calcium hydroxide and sufficient moisture for the calcium hydroxide to kill any organisms on the surface which is being coated, whether the organisms are viruses, spores, mold, fungus or bacteria. Further, painting a surface with the calcium hydroxide based coating seals off any pathogenic organism on the painted surface in the unlikely event that it is not been entirely killed by the calcium hydroxide in the coating. The decontaminating layer may be pigmented or clear, and may be applied to walls, ceilings, floors, furniture, etc. An area which has been decontaminated by painting it with the invented coating is safer than it was before the original contamination because it now has a working antimicrobial coating throughout all surfaces of the environment. Such a decontaminated area is much easier for displaced workers and residents to return to after a contamination event than one which has merely been purged with toxic chlorine dioxide gas.

Additionally, once an area has been painted with an invented calcium hydroxide based coating, it may be subsequently decontaminated by merely wiping the painted surfaces with a damp rag. The damp rag picks up some organisms, viruses, bacteria, mold, fungus, etc., and is disposed of. Additionally, however, the dampness of the rag both (1) brings any organisms on the calcium hydroxide based coated surface into their hydrous state and (2) provides sufficient moisture to permit transportation of hydroxide ions from the calcium hydroxide into the organisms to kill the microbes.

Because the invented calcium hydroxide based coatings do not use expensive components nor toxic components, painting or repainting areas with the invented calcium hydroxide coatings may be done with no negative side effects.

### Example 13

### Decontaminating and Medicinal Soap.

Many early soaps for use by humans were lye-based. However, the cosmetic industry typically does not produce nowadays high alkalinity soaps. A novel use for the lime-based biocidal system disclosed herein is high lime, high pH soap for use specifically when a biocidal soap is desired to kill fungi, mold spores or other hard to kill organisms. A non-ionic soap, such as a glycerin-based soap, combined with an appropriate amount of surfactants and calcium hydroxide, may produce a useful bar of soap with an alkalinity of approximately pH12 or greater, preferably pH12.4 to 12.5. The glycerin or similar carrier prevents the calcium hydroxide from becoming neutralized from contact with atmospheric carbon dioxide. The soap's biocidal shelf life is thus very long, lasting years. When the soap is used, i.e., combined with water and rubbed back and forth, the water plus the moist calcium hydroxide provide the extremely high alkalinity needed to provide the biocidal killing system discussed herein sufficient to kill microbes, including spores.

It is hypothesized that the described soap with sufficient calcium hydroxide to provide a high alkalinity of approximately pH12 or more when used will be useful for persons such as postal workers or medical personnel to scrub down with at the end of their shift for a thorough killing of bacteria and other organisms, even including hard to kill spores, such as anthrax. Topical application of such a soap is hypothesized to be effective in treating warts, acne, athletes foot, fungus and other surface and just-below-the-surface maladies which are caused by hard to kill foreign microbes. Creams for such uses may be preferably applied for seven to ten days to the skin although experimentation will be used to vary pH and duration.

### Example 14

### Prevention of Infection.

A nosocomial or hospital acquired infection is usually defined as one that first appears three days or more after a patient is admitted to the hospital or other healthcare facility. A substantial number of patients admitted to hospitals in the United States develop a hospital acquired or nosocomial infection. Young children, the elderly and persons with compromised immune systems are most likely to get such infections. Other risk factors include a long hospital stay and the use of long duration catheters. Each year, an estimated two million patients acquire a nosocomial infection in a U.S. hospitals causing more then 100,000 deaths. These infections cost approximately $4.5 billion annually.

Potentially harmful algae, bacteria and fungi may linger on dry surfaces, whether the surfaces is course, such as fabrics, or slick, such as plastics. Such surfaces in medical facilities include lab coats, toweling, privacy curtains, garments, scrub suits, nursing outfits, splash aprons, computer-keyboards, computer covers, medical equipment, walls, ceilings, floors, ductwork, pens, pencils, telephones, charts, door frames, handles, and other surfaces apparent to those in the art. Further, some germs are increasingly resistant to drugs and thus are harder to fight once a patient is infected. There is, therefore, a substantial market demand and a long felt need for practical methods of reducing nosocomial infections.

To minimize airborne contamination in surgical rooms, expensive methods such as high efficiency particle air filtered circulation systems that generate 15 to 20 air changes per hour, ultraviolet radiation, ultrafiltration flow systems, etc., are sometimes implemented. While these systems are sometimes used in surgical rooms, they are deemed too expensive to be practical for an entire hospital or other medical facility. This illustrates the expensive steps the medical community will go to lessen the odds of hospital caused infection.

All surfaces in hospitals may harbor microbes whether they are a lunch tray, the patient's hand, a privacy curtain, clothing, the computer keyboard, etc. Some microbes, in particular fungi, may survive for weeks on a hospital surface, waiting to be transferred to a susceptible patient. To spread dangerous antibiotic resistant enterococci and staphylococci microbes, the biggest problem pathogens in hospital infection, the microbes generally need only a resting place and something to touch them or disturb them to communicate them to the patient. Surfaces are considered the main vector carrier for diseases only second to human to human touch.

While some efforts have been made to make hospital gowns and other fabrics in the hospital less hospitable to harboring microorganisms by making them less permeable, a need exists to make garments and fabrics even more inhospitable to microorganisms which cause nosocomial infections.

As noted above, all surfaces in a hospital may be painted with the invented lime based latex paint. This includes walls, floors, ceilings, HVAC systems. Additionally, however, the invented coating may also be usefully applied to handles, medical equipment, desks, computer keyboards, plastic covers for computer keyboards, privacy curtains, blinds, window curtains, hospital furniture, janitorial equipment and supplies, etc. These several hospital surfaces as well as surfaces known to those in the field, may be usefully either comprised of, coated, or treated with the calcium hydroxide or lime based paints, materials or cleaning solutions of the instant invention.

A current standard method of killing microorganisms on surfaces is to disinfect the surface with a 10% solution of bleach. Bleach is not always useful for colored fabrics, carpets, furniture in the visitor area, etc. The invented coatings and treatments are more practically and esthetically useful than bleach solutions. Fabric materials such as gowns, furniture in visitor's lounges, chairs in the medical area, etc., may be comprised of or coated with the invented coatings for long term antimicrobial effect and subsequently washed with the invented treatments. Adding bleach to architectural surface increases the moister content of the substrate, which as a result creates inductive environment for further microbial population, particularly fungi (molds).

In the hospital setting, a common source of opportunistic infections is catheters and other medical devices which remain in contact with a susceptible part of the patient's body for an extended period of time. Such items may either be coated with or comprised of the invented materials so the items will both not harbor microorganisms and also not contain the toxins of other antimicrobial coatings.

Items which are currently made of plastic, such as privacy curtains, blinds, computer keyboards, hand rests, computer covers, counter tops, handles and the like may have the invented coating manufactured integrally with the base material or they may have the invented coating coated onto the base material during manufacture or applied at the hospital. Application at the hospital may either be by painting or spraying; one time or at intervals.

As an illustrative example, computer monitors and keyboards reside in each intensive care room. For patients with lesser needs, computer monitors and keyboards are present in each nurse's station. Each time a patient is checked or treated information is taken from and inputted into computers via the computer keyboard. The monitor screen is often touched. The paper instructions and logs are read, worked on, filed, received, etc. Medical personnel, who may be careful to change disposable gowns and masks between patients, often use the same pens, pencils, mini-flashlights, stethoscopes, etc., all day every day for months. These items may all be protected with the invented coatings, materials and treatments.

It will be understood by those with skill in the art that the invented coating for such devices must be designed to not irritate the patient or hospital personnel while yet still providing sufficient alkalinity to the surface to at least inhibit colonization by microorganisms, if not sufficient alkalinity to kill microorganisms.

These and other precautions against infection may also be used in veterinary clinics, nursing homes, rest homes, out-patient clinics and other facilities which will be apparent to those with ordinary skill in the art.

### Example 15

### Induction of Vegetative State.

Work reported by the University of Michigan shows that of nutrient compositions can be applied to surfaces to cause spores to vegetate. Microbes are much easier to kill when they are in a vegetative rather than a spore state. The University of Michigan's technique, however, requires that any such surface must be subsequently treated with a biocidal substance or composition to destroy the vegetative cells. The invented biocidal coating, however, may be used in combination with nutrients and a humectant to convert spores into a vegative state and killed by the coating's alkalinity. Nutrient compositions and/or moisture may be periodically applied without the need of applying new biocidal coatings.

It is another aspect of the present invention that surfaces, as discussed above, be first covered with the coatings or paints hereof and subsequently have a moist nutrient composition applied to it. If the nutrient composition is applied to the invented coating having spores on it, the nutrient composition will contain enough moisture to first cause the spores to vegetate and to subsequently ensure destruction of spores and any vegetative cells. This eliminates the need for further application of a biocidal agent after application of the nutrient composition.

In some embodiments of the invention, water and nutrients may be added to the environment, such as via a mist spray, small waterfall, etc., to improve the effectiveness of the invention. Sufficient moisture may be added to the air to sufficiently hydrate a humectant in the biocidal layer to a spore or microorganism which contacts the biocidal layer. In other embodiments, such as possibly in a HVAC conduit, misting with nutrients may be used to directly turn spores into the bacteria's vegetative state. A mist spray may, for example, be located in and confined to an HVAC conduit. Once bacteria are in a vegetative state, they may be more easily killed by contact with alkalinity from a calcium hydroxide based coating.

### Example 16

### Virus Protection.

Alistagen Corporation has conducted viral study, Study No. SWRI-96-01, Protocol No. SWRI062096, in compliance with the GLP regulations (Title 21 CFR 58) to determine the antiviral activity of Caliwel BNA (referred as Caliwel or BNA) antibiotic paint or coating, which was painted on plastic mesh sheeting and allowed to dry. As a result, Polioviurs type 1, Herpesvirus hominis type 1 and parainfluenza virus type 3 were inactivated within one hour by exposure to test article BNA Water Based Paint and test article BNA Solvent Based Paint.

Poliovirus, Herpesvirus hominis, and Parainfluenza virus. The viral study was undertaken to determine the antiviral activity of Caliwel paint or coating which was painted on plastic mesh sheeting and allowed to dry. Such antiviral activity would be useful in circumstances where an architectural surface such as walls, floors, ceilings, heating and ventilation system surfaces, or other such surfaces that might get contaminated with viruses. Poliovirus, Herpesvirus hominis (herpes simplex virus), and Parainfluenza virus were selected as representatives of three virus groups with different biological properties and different tissue tropisms resulting in central nervous system, mucosal or respiratory infections such as Bird flu.

The objective of the study was to determine whether the test article paint specimens were capable of inactivating poliovirus type 1, and parainfluenza virus type 3 infectivity when the viruses were exposed to surfaces covered with the Caliwel BNA antibiotic paint. Such antiviral activity is useful in circumstances where potential human pathogens might contaminate a surface. Contaminated surfaces are the main vector carrier for diseases such as Avian flu or H5N1 virus, next to bird to human to human touch. This invention relates to the first safe, non-hazardous to humans and animals and non-invasive way of cutting the link of cross-contamination of Avian flu and H5N1 virus. By treating hard surfaces such as walls, floors, ceilings and inside the heating, ventilation and air-conditioning systems with Caliwel BNA coating the dissemination of disease will be prevented or significantly reduced and human exposure to contagions virus will be minimized.

Poliovirus, Herpesvirus hominis (herpes simplex virus), and Parainfluenza virus were selected as representatives of three virus groups with different biological properties and different tissue tropisms resulting in central nervous system, mucosal or respiratory infections.

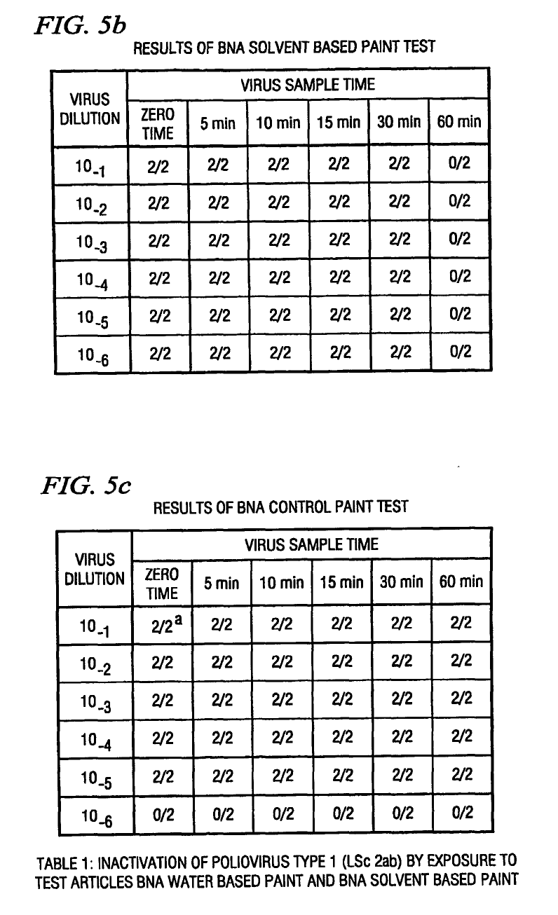

FIG. 5 shows the inactivation of poliovirus type 1 (LSc 2ab) by exposure to test articles coated with BNA water based paint (FIG. 5A), BNA solvent based Paint (FIG. 5B), and control paint (FIG. 5C).

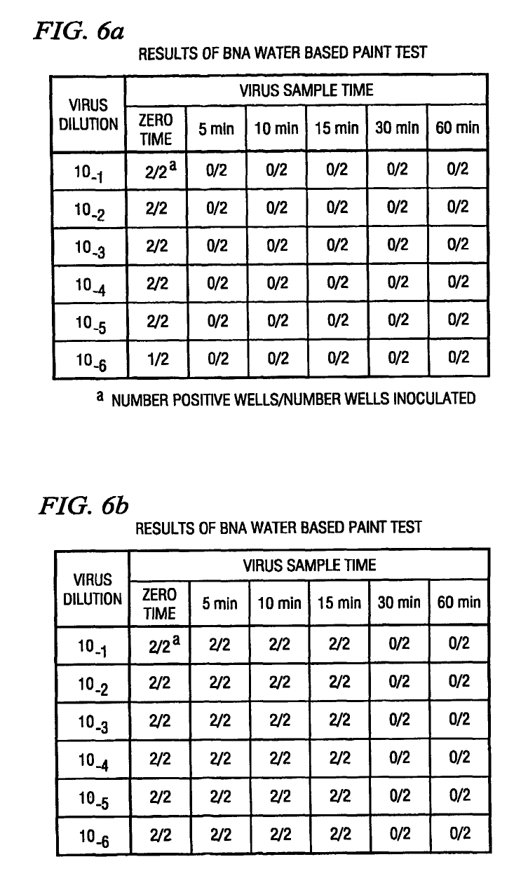

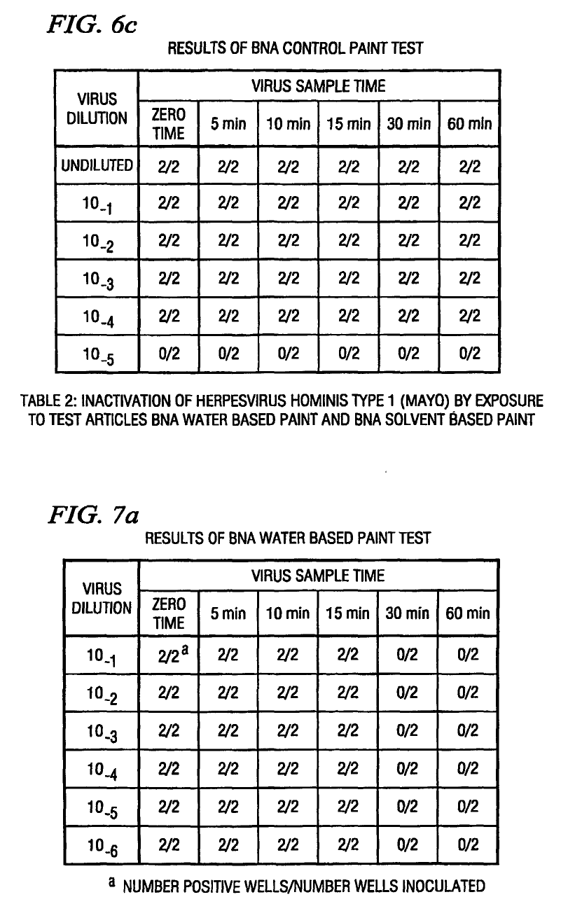

FIG. 6 shows the inactivation of Herpesvirus hominis type 1 by exposure to test articles coated with BNA water based paint (FIG. 6A), BNA solvent based Paint (FIG. 6B), and control paint (FIG. 6C).

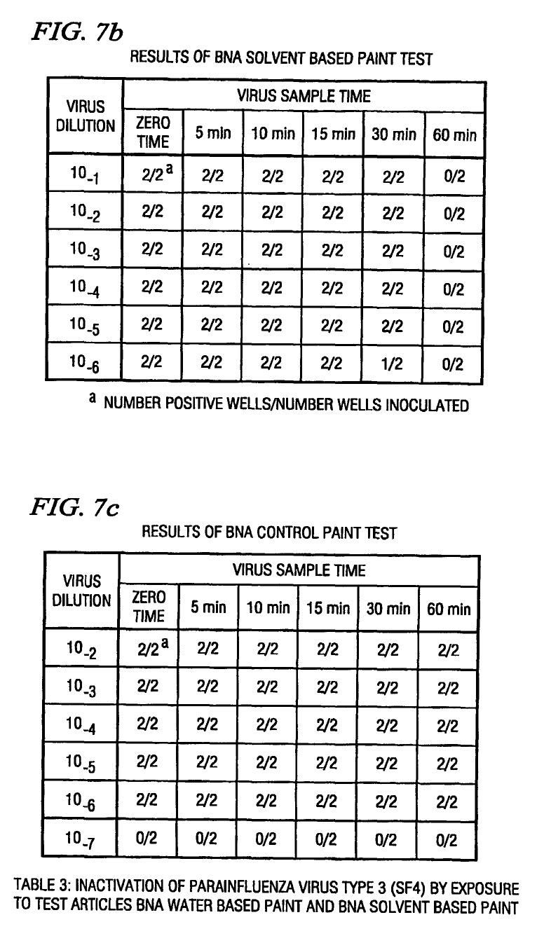

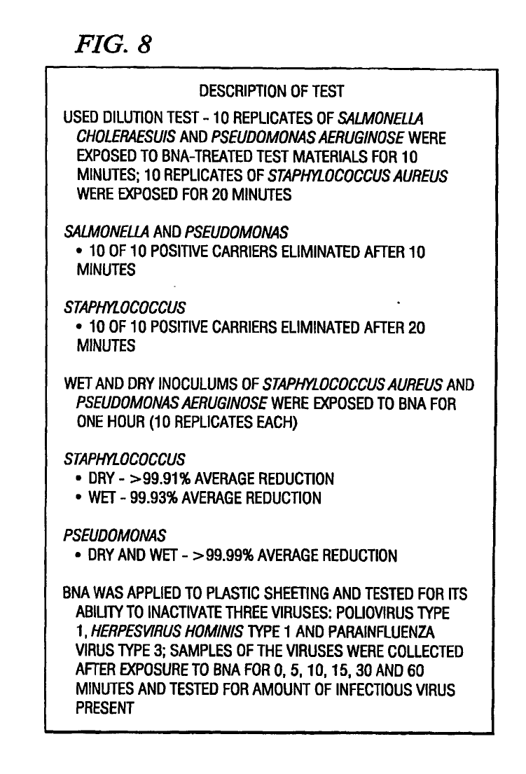

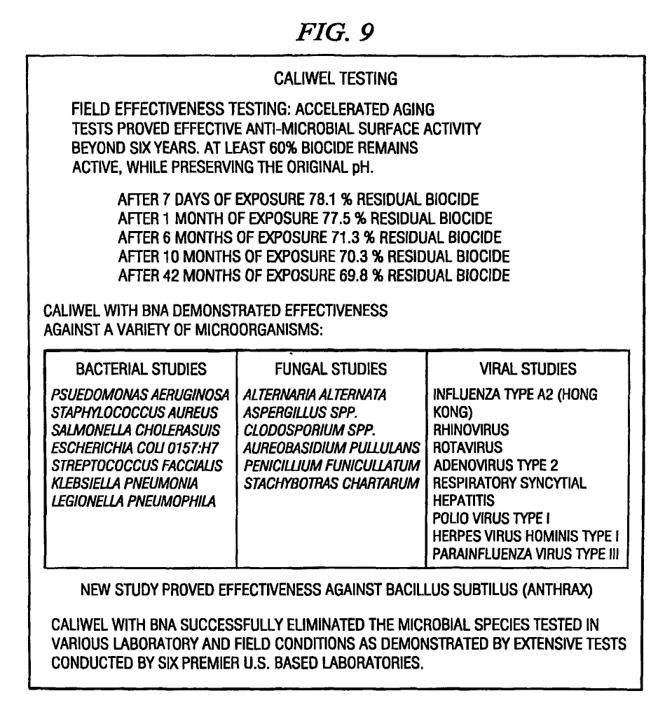

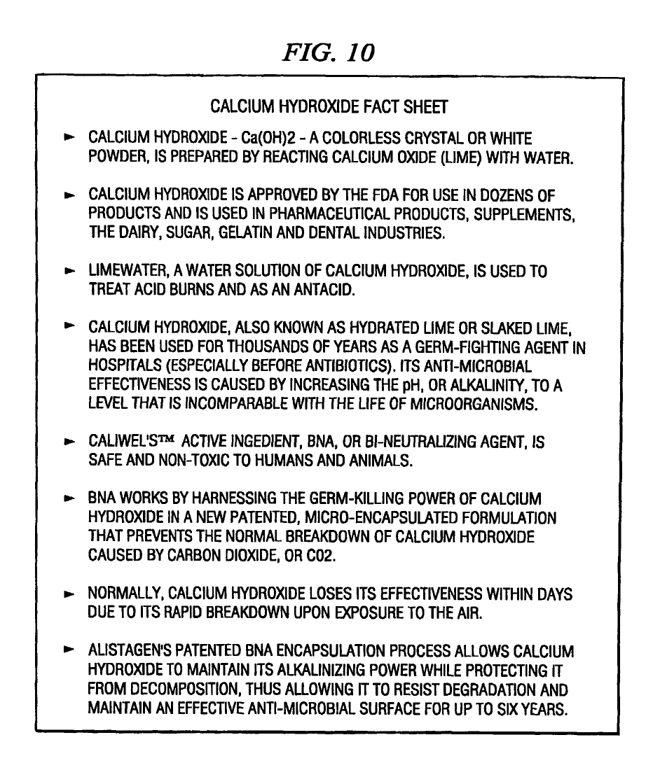

FIG. 7 shows the inactivation of Herpesvirus hominis type 1 by exposure to test articles coated with BNA water based paint (FIG. 7A), BNA solvent based Paint (FIG. 7B), and control paint (FIG. 7C).

Poliovirus type 1, Herpesvirus hominis type 1 and Parainfluenza virus type 3 were inactivated less then 60 minutes by exposure to test article Caliwel. Although not wanting to be bound by theory, the Caliwel could inactivate N5H1 strain and be widely used in various forms of human and animal protection. The present application of Caliwel is in the form of an architectural coating or paint. The U.S. EPA has granted registration of this product EPA Reg. No. 73696-2, EPA Est. No. 74842-NC-001 for use as an antimicrobial architectural paint. The product has been in the market since 2003.

The test articles, two samples of paint (BNA Water Based and BNA Solvent Based Paints—namely Caliwel) applied to plastic sheeting, were tested for their ability to inactivate three viruses, poliovirus type 1, Herpesvirus himinis type 1, and parainfluenza virus type 3. Suspensions of the virus were placed on 25 mm square pieces of the plastic sheeting coated with the two test article paints. Samples of the virus were collected after 0, 5, 10, 15, 30, and 60 min and tested for the presence of infectious virus. Virus was also placed on plastic sheeting with a biocide-free (BNA Control) paint as a control.

The BNA Water Based Paint inactivated 10_{8.7} TCID₅₀ of poliovirus in 30 min, 10_{5.7} TCID₅₀ of Herpesvirus hominis in five min, and 10_{7.7} TCID₅₀ of parainfluenza virus in 30 min. The Solvent Based Paint required 60, 30, and 15 min to activate the same amounts of the three viruses. The control sheeting produced no virus inactivation after an hour of exposure.

Components of the two paints which eluted within 10-15 min into culture medium added to the test article samples were toxic for the cell cultures used to assay the viruses under study. This toxicity was markedly reduced by washing the paint coated squares in demineralized water for 10 min. This procedure was adopted to perform the study.

The objective of the study was to determine whether the test article paint specimens were capable of inactivating poiovirus type 1, Herpesvirus hominuis type 1, and parainfluenza virus type 3 inactivity when the viruses were exposed to surfaces covered with the paints.

Test Article. Two test article paints were studied. Test article BNA Water Based Paint and BNA Solvent Based Paint painted on separate plastic sheets, approximately 40×30 cm in size, were received on Jun. 21, 1996 and Jul.10, 1996 respectively. A control of plastic sheeting with BNA Control was received Jun. 20, 1996.

Identity, strength, composition, purity and stability of the test articles is determined by the Sponsor.

Ten-fold virus dilutions of virus were exposed to the paints and the BNA Control plastic sheet. The virus dilutions were sampled at intervals to determine the point of complete inactivation.

The test articles, consisting of paint applied to a plastic mesh sheeting were cut into 25×25 mm squares with a paper cutter and the squares stored at room temperature in an envelope until tested. The plastic sheeting control paint (BNA Control) was also cut into 25×25 mm squares and stored at room temperature until tested.

Test for antiviral activity of the paint. Prior to use, the squares of test article and control were washed in approximately 100 ml of deionized water for 15 min to remove cytotoxic substances. After blotting on paper toweling, one square for each test article and the control was placed in each well of sterile, six-well (35 mm diameter wells) polystyrene cell culture dishes. Two plates were prepared for squares of each paint (for assay of the test article with virus and the test article with cell culture medium for the cell toxicity control) and one plate with BNA Control Paint plastic squares (control with virus). The test article plates and control for virus inactivation were repeated for each virus.

Based on the pretest titration of the test viruses (Herpesvirus hominis type 1, poliovirus type 1 and parainfluenza virus type 3), ten-fold dilutions were prepared to the titer endpoint and 2.0 ml aliquots of each of the six highest dilutions were placed in one of six wells of the test article and control plates. The toxicity control wells received 2.0 ml of culture medium (Eagle's Minimal Essential Medium containing 10% fetal bovine serum). In each case the virus suspensions and control medium was distributed over the surface of the plastic squares by rocking the plate.

At intervals (0, 5, 10, 15, 30, 60 minutes), 0.2 ml sample from each well were removed and inoculated into two wells of a susceptible cell culture (0.1 ml per well) in a 24-well culture plate. MA104 cells were used for Herpesvirus hominis and poliovirus, and Vero (E6) cells for parainfluenza virus type 3.

The inoculated cultures were examined for cytopathology (CPE) or evidence of cell toxicity every 2-3 days for one week. Any evidence of toxicity (toxicity control) and the titers for each virus on the test article and control sheeting for each time

Poliovirus type 1 (strain LSc 2ab) was used to prepare a test virus pool by inoculation 0.5 ml of seed virus onto a drained monolayer of MA 104 cells in a T-25 polystyrene cell culture flask. The flask was incubated at 37C for one hr and 10 ml of medium (EMEM) was added to the flask. The flask was returned to 37C and when cytopathology was 4+ the flask was frozen and thawed three times. The culture medium was centrifuged at 1500 rpm for 15 min and the supernatant fluid use to perform the assay following titration.

A Herpesvirus hominis type 1 (strain Mayo) working virus pool was prepared in the same way that the poliovirus pool was made.

Parainfluenza virus type 3 (strain SF4) working pool was made by inoculation 0.5 ml of virus seed onto a drained monolayer of Vero (E6) cells in a T-25 polystyrene cell culture flask. The flask was incubated at 37C for one hr and 10 ml of medium was added to the flask. The flask was returned to 37C and harvested when 3+ CPE was noted. The flask was frozen and thawed three times, culture medium centrifuged at 1500 rpm for 15 min and the supernatant fluid used to perform the assay following titration.

MEME- Eagle's Minimal Essential Medium (cellgro, 10-010-LM) containing 10% fetal bovine serum (Summit, S-100-65), MA 104-Rhesus monkey kidney cell line, passage 54 through 56, grown on MEME. Vero (strain E6)-African green monkey kidney cell line, passage 32 and 33, grown on MEME.

### IV Results:

Poliovirus type 1 inoculum had a titer of 10_{7.5} TCID₅₀ (50% Tissue Culture Infectious Dose endpoint)/0.1 ml, therefore, 10_{8.7} TCID₅₀ were used in the 2.0 ml of virus applied to each paint sample. This amount of virus was inactivated after exposure to the BNA Water Based Paint for 30 min and after exposure to the BNA Solvent Based Paint for one hour, and none of the viruses were affected by exposure to the control plastic sheeting (FIGS. 5 (A-C), Table 1).

Herpesviurs hominis (herpes simplex virus) type 1 had a titer of 10_{5.5} TCID₅₀/0.1 ml or 10_{5.7} TCID₅₀ in the 2.0 ml test volume. This amount of virus was inactivated after exposure to the BNA Water Based Paint for 5 min and after exposure to the BNA Solvent Based Paint for 30 min, and none of the viruses were affected by exposure to the control plastic sheeting (FIGS. 6 (A-C), Table 2).

Parainfluenza virus type 3 had a titer of 10_{6.5} TCID₅₀/0.1 ml or 10_{7.7} TCID₅₀ in the 2.0 ml test volume. This amount of virus was inactivated after exposure to the BNA Water Based Paint for 30 min and after exposure to the BNA Solvent Based Paint for 60 min, and none of the viruses were affected by exposure to the control plastic sheeting (FIGS. 7 (A-C), Table 3).

Within 10 to 15 min of exposure of the test article paints to MEME enough toxic materials eluted from the paint to kill the rest cells on exposure. This apparent toxicity could be removed from the paint squares by washing them in approximately 100 ml of demineralized water for 15 min.

H5N1 Bird Flu Virus. Applicants invention may be extended to other types of viruses, for example H5N1 Bird Flu Virus. According to World Health Organization, “the main route of human infection” from birds is direct contact with infected poultry, or surfaces and objects contaminated by their droppings. Experts estimate if H5N1 mutates and acquires the ability to spread easily from person to person, it could make more than hundreds of millions people seriously ill and kill as many. H5N1 has death rate of 55% of all people infected with the virus, compared to Spanish flu that had only 6%. In four Asian nations since late 2003, the Avian Flu has killed or forced the destruction of tens of millions of poultry. Experts say it is mutating steadily and fear it will eventually acquire the changes it needs to spread easily from person to person. If it does, it will sweep around the world in months or even weeks and could reduce the world's population by one third, according to the forecast by the World Health Organization (October 2005). A study published last week showed that the H1N1 virus that caused the 1918 flu pandemic, which killed at least 40 million people globally and may have killed more, depending on estimates, was a purely avian virus that acquired a few mutations that gave it the ability to infect people easily, spread among them and cause highly fatal disease. H5N1 is mutating in a similar way and experts believe it is only a matter of time before it, too, infects people easily.

Bird flu spreads when infected birds shed flu virus in their saliva, nasal secretions, and feces. Susceptible birds become infected when they have contact with contaminated excretions or surfaces that are contaminated with excretions. It is believed that most cases of bird flu infection in humans have resulted from contact with infected poultry or contaminated surfaces.

The H5N1 virus does not usually infect humans. However, the risk to humans contracting H5N1 virus from birds has been confirmed. In 1997, however, the first case of spread from a bird to a human was seen during an outbreak of bird flu in poultry in Hong Kong. The virus caused severe respiratory illness in 18 people, 6 of whom died. Since that time, there have been other cases of H5N1 infection among humans. Most recently, human cases of H5N1 infection have occurred in Thailand, Vietnam and Cambodia during large H5N1 outbreaks in poultry. The death rate for these reported cases has been about 50 percent. Most of these cases occurred from contact with infected poultry or contaminated surfaces; however, it is thought that the virus has not yet mutated to be transmitted from human-to-human. However, if a human-to-human variant of the H5N1 appears, the world health organization predicts that a world-wide pandemic will occur at a cost of hundreds of millions of human lives.

Because these viruses do not commonly infect humans, there is little or no immune protection against them in the human population. If the H5N1 virus were able to infect people and spread easily from person to person, an “influenza pandemic” (worldwide outbreak of disease) could begin. No one can predict when a pandemic might occur. However, experts from around the world are watching the H5N1 situation in Asia very closely and are preparing for the possibility that the virus may begin to spread more easily and widely from person to person.

The H5N1 virus currently infecting birds in Asia that has caused human illness and death is resistant to amantadine and rimantadine, two antiviral medications commonly used for influenza. Two other antiviral medications, oseltamavir and zanamavir, would probably work to treat flu caused by the H5N1 virus.

### V. Conclusions

Polioviurs type 1, Herpesvirus hominis type 1 and parainfluenza virus type 3 were inactivated within one hour by exposure to test article BNA Water Based Paint and test article BNA Solvent Based Paint.

### VI. Tables

TABLE 1
Inactivation of Polioviurs type 1 (LSc 2ab) by exposure to
test articles BNA Water Based Paint and BNA Solvent Based Paint.

| | VIRUS SAMPLE TIME | | | | | |
|---|---|---|---|---|---|---|
| VIRUS | ZERO | | | | | |
| DILUTION | TIME | 5 min | 10 min | 15 min | 30 min | 60 min |

a. Results of BNA Water Based Paint

| | | | | | | |
|---|---|---|---|---|---|---|
| 10-1 | 2/2^{a} | 2/2 | 2/2 | 2/2 | 0/2 | 0/2 |
| 10-2 | 2/2 | 2/2 | 2/2 | 2/2 | 0/2 | 0/2 |
| 10-3 | 2/2 | 2/2 | 2/2 | 2/2 | 0/2 | 0/2 |
| 10-4 | 2/2 | 2/2 | 2/2 | 2/2 | 0/2 | 0/2 |
| 10-5 | 2/2 | 2/2 | 2/2 | 2/2 | 0/2 | 0/2 |
| 10-6 | 2/2 | 2/2 | 2/2 | 0/2 | 0/2 | 0/2 |

b. Results of BNA Solvent Based Paint test:

| | | | | | | |
|---|---|---|---|---|---|---|
| 10-1 | 2/2 | 2/2 | 2/2 | 2/2 | 2/2 | 0/2 |
| 10-2 | 2/2 | 2/2 | 2/2 | 2/2 | 2/2 | 0/2 |
| 10-3 | 2/2 | 2/2 | 2/2 | 2/2 | 2/2 | 0/2 |
| 10-4 | 2/2 | 2/2 | 2/2 | 2/2 | 2/2 | 0/2 |
| 10-5 | 2/2 | 2/2 | 2/2 | 2/2 | 2/2 | 0/2 |
| 10-6 | 2/2 | 2/2 | 2/2 | 2/2 | 2/2 | 0/2 |

^{a}Number positive wells/Number wells inoculated.

TABLE 2
Inactivation of Herpesviurs hominis type 1 (Mayo) by exposure
to test articles BNA Water Based Paint and BNA
Solvent Based Paint.

| | VIRUS SAMPLE TIME | | | | | |
|---|---|---|---|---|---|---|
| VIRUS | ZERO | | | | | |
| DILUTION | TIME | 5 min | 10 min | 15 min | 30 min | 60 min |

a. Results of BNA Water Based Paint test:

| | | | | | | |
|---|---|---|---|---|---|---|
| 10-1 | 2/2^{a} | 0/2 | 0/2 | 0/2 | 0/2 | 0/2 |
| 10-2 | 2/2 | 0/2 | 0/2 | 0/2 | 0/2 | 0/2 |
| 10-3 | 2/2 | 0/2 | 0/2 | 0/2 | 0/2 | 0/2 |
| 10-4 | 2/2 | 0/2 | 0/2 | 0/2 | 0/2 | 0/2 |
| 10-5 | 2/2 | 0/2 | 0/2 | 0/2 | 0/2 | 0/2 |
| 10-6 | 1/2 | 0/2 | 0/2 | 0/2 | 0/2 | 0/2 |

c. Results of BNA Solvent Based Paint test:

| | | | | | | |
|---|---|---|---|---|---|---|
| 10-1 | 2/2 | 2/2 | 2/2 | 2/2 | 0/2 | 0/2 |
| 10-2 | 2/2 | 2/2 | 2/2 | 2/2 | 0/2 | 0/2 |
| 10-3 | 2/2 | 2/2 | 2/2 | 2/2 | 0/2 | 0/2 |
| 10-4 | 2/2 | 2/2 | 2/2 | 2/2 | 0/2 | 0/2 |
| 10-5 | 2/2 | 2/2 | 2/2 | 2/2 | 0/2 | 0/2 |
| 10-6 | 0/2 | 0/2 | 0/2 | 0/2 | 0/2 | 0/2 |

^{a}Number positive wells/Number wells inoculated.

TABLE 3
Inactivation of parainfluenza virus type 3 (SF4) by exposure
to test articles BNA Water Based Paint and BNA
Solvent Based Paint.

| | VIRUS SAMPLE TIME | | | | | |
|---|---|---|---|---|---|---|
| VIRUS | ZERO | | | | | |
| DILUTION | TIME | 5 min | 10 min | 15 min | 30 min | 60 min |

a. Results of BNA Water Based Paint test:

| | | | | | | |
|---|---|---|---|---|---|---|
| 10-1 | 2/2^{a} | 2/2 | 2/2 | 2/2 | 0/2 | 0/2 |
| 10-2 | 2/2 | 2/2 | 2/2 | 2/2 | 0/2 | 0/2 |
| 10-3 | 2/2 | 2/2 | 2/2 | 2/2 | 0/2 | 0/2 |
| 10-4 | 2/2 | 2/2 | 2/2 | 2/2 | 0/2 | 0/2 |
| 10-5 | 2/2 | 2/2 | 2/2 | 2/2 | 0/2 | 0/2 |
| 10-6 | 2/2 | 2/2 | 2/2 | 2/2 | 0/2 | 0/2 |

b. Results of BNA Solvent Based Paint test:

| | | | | | | |
|---|---|---|---|---|---|---|
| 10-1 | 2/2^{a} | 2/2 | 2/2 | 2/2 | 2/2 | 0/2 |
| 10-2 | 2/2 | 2/2 | 2/2 | 2/2 | 2/2 | 0/2 |
| 10-3 | 2/2 | 2/2 | 2/2 | 2/2 | 2/2 | 0/2 |
| 10-4 | 2/2 | 2/2 | 2/2 | 2/2 | 2/2 | 0/2 |
| 10-5 | 2/2 | 2/2 | 2/2 | 2/2 | 2/2 | 0/2 |
| 10-6 | 2/2 | 2/2 | 2/2 | 2/2 | 1/2 | 0/2 |

^{a}Number positive wells/Number wells inoculated.

TABLE 4
Inactivation of Poliovirus type 1 (LSc 2ab), Herpesvirus hominis
and parainfluenza virus type 3 (SF4) by exposure to
BNA Control Paint:

| | VIRUS SAMPLE TIME | | | | | |
|---|---|---|---|---|---|---|
| VIRUS | ZERO | | | | | |
| DILUTION | TIME | 5 min | 10 min | 15 min | 30 min | 60 min |

a. Polioviurs type 1:

| | | | | | | |
|---|---|---|---|---|---|---|
| 10-1 | 2/2^{a} | 2/2 | 2/2 | 2/2 | 2/2 | 2/2 |
| 10-2 | 2/2 | 2/2 | 2/2 | 2/2 | 2/2 | 2/2 |
| 10-3 | 2/2 | 2/2 | 2/2 | 2/2 | 2/2 | 2/2 |
| 10-4 | 2/2 | 2/2 | 2/2 | 2/2 | 2/2 | 2/2 |
| 10-5 | 2/2 | 2/2 | 2/2 | 2/2 | 2/2 | 2/2 |
| 10-6 | 0/2 | 0/2 | 0/2 | 0/2 | 0/2 | 0/2 |

b. Herpesvirus hominis Type 1:

| | | | | | | |
|---|---|---|---|---|---|---|
| Undiluted | 2/2 | 2/2 | 2/2 | 2/2 | 2/2 | 2/2 |
| 10-1 | 2/2 | 2/2 | 2/2 | 2/2 | 2/2 | 2/2 |
| 10-2 | 2/2 | 2/2 | 2/2 | 2/2 | 2/2 | 2/2 |
| 10-3 | 2/2 | 2/2 | 2/2 | 2/2 | 2/2 | 2/2 |
| 10-4 | 2/2 | 2/2 | 2/2 | 2/2 | 2/2 | 2/2 |
| 10-5 | 0/2 | 0/2 | 0/2 | 0/2 | 0/2 | 0/2 |

^{a}Number positive wells/Number wells inoculated.

TABLE 4
Inactivation of Poliovirus type 1 (LSc 2ab), Herpesvirus hominis
and parainfluenza virus type 3 (SF4) by exposure to
BNA Control Paint.
c. Parainfluenza virus type 3:

| | VIRUS SAMPLE TIME | | | | | |
|---|---|---|---|---|---|---|
| VIRUS | ZERO | | | | | |
| DILUTION | TIME | 5 min | 10 min | 15 min | 30 min | 60 min |
| 10-2 | 2/2^{a} | 2/2 | 2/2 | 2/2 | 2/2 | 2/2 |
| 10-3 | 2/2 | 2/2 | 2/2 | 2/2 | 2/2 | 2/2 |
| 10-4 | 2/2 | 2/2 | 2/2 | 2/2 | 2/2 | 2/2 |
| 10-5 | 2/2 | 2/2 | 2/2 | 2/2 | 2/2 | 2/2 |
| 10-6 | 2/2 | 2/2 | 2/2 | 2/2 | 2/2 | 2/2 |
| 10-7 | 0/2 | 0/2 | 0/2 | 0/2 | 0/2 | 0/2 |

^{a}Number positive wells/Number wells inoculated.

### Example 17

### Termites and Insects.

White wash is traditionally used around the world to kill the taste fly larva as these larva grow in the bark pockets of trees, below about 4 feet from the ground. By white washing to the 4 ft level, you kill the larva. According to industry sources it is expected for lime wash to also kill termite larva upon exposure. Shortly in the matter of days and weeks the lime absorbs carbon dioxide (CO₂) from the air which decreases the pH of the lime and converts the lime into calcium carbonate (it carbonates). Upon that natural process the lime rapidly looses the high pH and ability to kill larva or termites. If trees are to retain lime protection from larva, termites and insects frequent re-application of lime to tree is required. Such process is very labor intensive and economically unfeasible.

Caliwel is designed to utilize all the positive attributes of lime as its active ingredient. However, Caliwel contains specifically engineered micro-encapsulated mode of action called Bi-Neutralizing Agent (BNA), which has the ability to function in a liquid latex system to block the permeation of CO₂, while allowing the water vapor and microbes to penetrate through the BNA semi-permeable, selectively permeable membrane where reacts with lime and causes microbial enzyme to brake down.

The use of Caliwel to protect trees from its natural enemies is considered as extremely useful and economically feasible way. Lime is a natural occurring mineral derived from earth. It is imperative to solve the problem while preserving the natural, ecological balance. The procedure of painting 4 feet of tree will be unchanged from the already established tradition; however, since Caliwel retains the high pH the frequent re-application would not be required. Caliwel has the initial pH of 12.454, which gradually over period of years (4-6), depending on the conditions degrades to pH 9. The Caliwel treatment would be required every approximately four to six years depending on the environmental conditions. Such long term protection would preserve the natural integrity of trees while immensely reducing the cost and labor expense.

### Example 18

### Encapsulated and Nano-Particulate Biocides:

The present example concerns hydrated lime biocidal technology that is related to the biocidal coating technology described in U.S. Pat. No. 6,042,638, U.S. Pat. No. 6,280,509, and U.S. Pat. No. 6,231,650, which are specifically incorporated their entirety by reference herein.

It is known that hydrated calcium hydroxide (Ca(OH)₂, slaked lime, hydrated lime) which has a pH 12 and above is sufficiently alkaline to be biocidal. However, carbon dioxide in the ambient atmosphere over time converts calcium hydroxide to calcium carbonate, which does not have sufficient alkalinity to kill microorganisms. The calcium hydroxide also acts to degrade conventional coating binders. The above-referenced patents provide coating compositions which both (1) delay the carbonization of calcium hydroxide via contact with the atmosphere (2) use binders which are not degraded or otherwise adversely affected by the hydrated lime, and (3) which are permeable to moisture, but not carbon dioxide.

The combination of sufficient retardation of the speed with which the calcium hydroxide is carbonated and selective coating binders which are not adversely affected by the calicum hydroxide and are selectively permeable as noted, but cannot be used with all binders, particularly all the polyolefinic latexes useful in paints.

The technology of the above patents used calcium hydroxide in combination with a cellulose polymer or certain non-ionic polyolefinic latexes. However, this is not possible for all materials or functions and is an optimum means for achieving a practical biocidal product for only some materials or functions. A need exists for new methods and compositions which permit calcium hydroxide's nontoxic biocidal effect to be best used in other materials and functions.

In one embodiment, the present invention accomplishes the dual tasks of retarding carbonization of calcium hydroxide and use of binder materials including compositions including those commonly degraded or otherwise adversely affected by calcium hydroxide. This is accomplished by forming the calcium hydroxide into nanoparticles usually having a size of 0.1 nanometer to 110 nanometers in size. These nanoparticles then can be added to any binder without the need for the special binders discussed above. While the precise theory is not completely understood, it is believed that nanosizing of the calcium hydroxide causes it to have different physical and chemical properties than the parent material. More specifically, while it retains its alkalinity and thus its biocidal properties, it does not act to degrade the polyolefinic latex binders commonly used in coatings, such as paints, and other binders and thereby eliminates the need for precoating the calcium hydroxide with a cellulose polymer or the need to use a non-ionic polyolefinic latex as a binder.

The useful biocidal nanoparticles may be produced by any technique used to form nanosized particles such as the methodology described in U.S. Pat. No. 5,783,263 and U.S. Pat. No. 5,585,020, incorporated in their entirety by reference herein. The most suitable method can be chosen by routine experimentation.

In another embodiment, the calcium hydroxide is encapsulated to physically separate it from the binder or carrier. The encapsulated calcium hydroxide particles must be sufficiently small to be mixed with the carrier or substrate without so defeating the desired characteristics of the carrier that the carrier becomes unuseful for its intended purpose. The encapsulated calcium hydroxide particles are primarily inert particles with respect to the carrier and do not materially adversely affect the structural properties of the carrier. In other embodiments, the encapsulated particles may be designed to favorably affect the carrier's characteristics.

Either embodiment permits sufficient communication of the calcium hydroxide's alkalinity to the coating's surface or immediate subsurface so the coating is biocidal for a useful period of time. The combination of sufficient retardation of the speed with which the calcium hydroxide is carbonated and facilitation of sufficient communication of biocidal alkalinity make the methods and compositions of these above patents practical.

Encapsulation involves making a fine particle the active core within an outer shell. Encapsulation can be applied to any scale. Most typically, encapsulation prevents ingredients from reacting prematurely with their environment or degrading during processing or storage. In the subject invention, encapsulation technology is used to protect the calcium hydroxide core material from carbonization, communicate alkalinity, facilitate handling and dispersion of the calcium hydroxide and, in some case, permitting a sustained release of the calcium hydroxide's alkalinity over a period of time. The encapsulating material may either be organic or inorganic. The micro encapsulate may be hydrophilic or hydrophobic as well as solid or liquid. The encapsulated payload of biocidal material may be as low as 20% or as high as 99%. The capsules may preferably range in size from less than 1 micron and up to 2,000 microns in size, although larger capsules may be useful. Powders of encapsulated calcium hydroxide may be produced. If, for example, at the time of consolidation, the encapsulation material is removed by vacuum annealing, the resulting powder remains unagglomerated.

An advantage of some of the invented nanoencapsulated biocides is that when some capsules are exposed to atmosphere, the core particles are protected from oxidation and/or hydrolysis. Use of calcium hydroxide or other biocidal agent as a mixable component of coatings or products is often greatly facilitated when they are encapsulated.

In another embodiment, a layer of encapsulated calcium hydroxide is placed on the substrate surface, whether it be metal, plastic or otherwise and then an outer coating is placed on top of the calcium hydroxide layer. The outer coating is both sufficiently permeable to communicate the calcium hydroxide's alkalinity to the outer surface of the coating and is also comprised to sufficiently retard carbonization of the calcium hydroxide from the ambient atmosphere for a practical period of time. Thus, laminated products in which the calcium hydroxide is protected from the atmosphere by an outer coating are possible. In a preferred such embodiment, a layer of calcium hydroxide protected by such a coating will communicate biocidal alkalinity to the surface for at least 30 days.

The chemical stability of the calcium hydroxide against oxidation is enhanced by encapsulation of calcium hydroxide within nanoparticles. It is believed that such nanoparticles may be used together with a cellolosic polymer of the above-described patents to produce products which have both a longer active life and are more effectively biocidal than those using the technology of U.S. Pat. No. 6,042,638; U.S. Pat. No. 6,280,509; and U.S. Pat. No. 6,231,650.

Nonlimiting examples of carriers that encapsulated calcium hydroxide particles may be added to and products that it may be applied or added to comprise substrate materials from which objects will be made such as plastic, wood pulp, paper, and metal consumables such as cosmetics, toothpaste and disinfectant liquids; coatings such as paint and finishes, grouts, and sealants. The invention is useful in pulp, paper packaging, styrofoam type containers, cellophane type coverings and the like. The quantity of encapsulated calcium hydroxide must be sufficient to make the resultant end product biocidal for a practical period of time, preferably at least 30 days. The examples given in the above patents for quantities and percentages of calcium hydroxide to produce useful results are expected to be applicable to the present invention without undue experimentation.

For a product with a desired biocidal surface such as a hospital curtain, apron, shower curtain or tile or a paint, the desired biocidal longevity may be a substantial period of time after the product is put in contact with the atmosphere, preferably at least 30 days. For these uses the encapsulation materials and carrier must collectively protect the calcium hydroxide from rapid atmospheric carbonization and perhaps even from repeated contact with water. On the other hand, for consumable products such as toothpaste, cosmetics, dentifrices, etc., the period of time during which the biocidal longevity is required is primarily the product's shelf life, during which the atmosphere and resultant carbonization may be excluded by packaging. Thereafter, the period of actual biocidal action for such products is relatively brief while the product is actually being used.

An additional method of extending the life of the product's biocidal effectiveness is to use constant or variable slow release capsules. A variant delivery system is aerosol delivery of the nanoencapsulated biocidal product to an area to be cleaned of microbes.

The intended use of the product thus dictates the extent to which the calcium hydroxide needs to be protected from carbonization and the amount volume and speed with which alkalinity is preferably communicated and the reservoir of alkalinity (calcium hydroxide) needed.

For products of the invention with a biocidal surface, the invention's encapsulated particles have a coating and the invention's carrier has sufficient permeability to permit sufficient communication of the calcium hydroxide's alkalinity from beneath the surface of carrier to the surface to make the surface of the carrier biocidal. While in some instances, the encapsulated calcium hydroxide may usefully be comprised of micro sized particles, the invention will be preferably comprised of nano sized encapsulated calcium hydroxide. It is believed that the physical attributes of nano sized particles typically permit better distribution within the carrier without interfering with the carrier's intended use while also conferring sufficient biocidal action.

The capsules of the invented nanoparticles and microparticles may be usefully formed from numerous substances and the hydrated calcium hydroxide (Ca(OH)₂, slaked lime or hydrated lime) or other source of alkalinity can be placed in various physical forms to enhance effectiveness, longevity, transparency, and other attributes as needed for the specific product.

The useful biocidal nanoparticles may be produced by any technique used to form nanosized particles such as the methodology described in U.S. Pat. No. 5,783,263 and U.S. Pat. No. 5,585,020, incorporated in their entirety by reference herein. The most suitable method can be chosen by routine experimentation. Methods of forming useful microparticles are described, for example, in U.S. Pat. No. 5,922,253, U.S. Pat. No. 6,022,564, U.S. Pat. No. 6,471,995, U.S. Pat. No. 6,395,304, and U.S. Pat. No. 6,375,985. Such encapsulation is also described, for example, in U.S. Pat. No. 5,194,262, U.S. Pat. No. 5,271,934 and U.S. Pat. No. 4,874,611 (antiperspirants and insect bait). Likewise, microencapsulation has been described for a variety of materials and agents in U.S. Pat. No. 6,406,719, U.S. Pat. No. 6,156,245, U.S. Pat. No. 6,146,665, U.S. Pat. No. 5,766,637, and U.S. Pat. No. 6,156,245. These patents are incorporated herein in pertinent part by reference herein for the methodologies they describe.

Wellinghoff of the Southwest Research Institute San Antonio, Tex. and others have authored U.S. Pat. Nos. 5,914,126, 6,194,481, 6,410,765, 5,922,776, 5,888,528, and 5,668,185, which describe various types of particulate formulations applicable to calcium hydroxide of the present invention and are incorporated by reference herein. Encapsulation technology has also been described in U.S. Pat. No. 6,291,537 (Ciminelli, et al.) incorporated by reference herein.

Nanoencapsulation may also be performed with the cellulose-encapsulated calcium hydroxide of the present invention, for example, as described in the U.S. Pat. No. 5,807,576 and U.S. Pat. No. 5,547,748 and the resultant nanoparticles added to the cellulose coatings of U.S. Pat. No. 6,042,638, U.S. Pat. No. 6,280,509, and U.S. Pat. No. 6,231,650 to enhance the desirable attributes of those biocidal coatings. These patents are incorporated in pertinent part by reference herein.

These various technologies enable the incorporation of encapsulated calcium hydroxide or other such biocidal material into a substrate materials such as plastic, wood pulp, and metals; consumables such as cosmetics, toothpaste, dentifrices, and disinfectant liquids; and coatings such as paint and finishes and a variety of other substances including cotton, paper, rubber, nylons, wood, metals, and harvested and unharvested agricultural products, etc.

The resultant biocidal action is preferably active for at least five to six years, and is preferably effective against all classes of microbes as demonstrated previously in the cited patents. The invention's biocidal action is preferably at least as effective as the results disclosed for the calcium hydrated coating set out in U.S. Pat. No. 6,042,638; U.S. Pat. No. 6,280,509 and U.S. Pat. No. 6,231,658.

If the product has a permanent outer surface, the invention's encapsulation coating and/or the carrier in combination provide both communication of the calcium hydroxide's alkalinity to the outer surface of the product while preventing or substantially delaying carbonization of the calcium hydroxide by contact with the atmosphere. Biocidal results and duration equal to those in the referenced patents U.S. Pat. No. 6,042,638, U.S. Pat. No. 6,280,509, and U.S. Pat. No. 6,231,650 are expected to the extent that the variant materials and means satisfy these requirements.

Products and coatings having the invented calcium hydroxide nanoparticles, however, are believed to be more biocidally effective and more long lived than the coating disclosed in those patents. Microencapultion and nanoencapsulation of calcium hydroxide by materials and means which prevent or delay carbonization of the calcium hydroxide by contact with the ambient atmosphere and which use alkalinity reservoirs other than calcium hydroxide and encapsulating materials other than cellulose layers are variants of the invention and within the invention's scope. Preferably, the invention is nontoxic and maintains an alkalinity effective to kill microorganisms after one month's exposure to a 100% carbon dioxide ambient atmosphere, which would otherwise carbonate calcium hydroxide in one to two days so that it would not be useful as a biocide. In another variant, the resultant invented product maintains its biocidal activity for five to six years, even when aged in a 100% carbon dioxide ambient atmosphere.

The encapsulated particles can be engineered to be trigger released via contact with moisture, such as in a cosmetic product where body moisture triggers biocidal effectiveness. In some formulations, it is preferable to add a humectant. One function of the humectant is to facilitate communication of the calcium hydroxide's alkalinity to the surface of the resultant product or coating so the outer surface will have sufficient biocidal activity to kill most microorganisms.

While the precise theories of all of the invention's actions and effects are not completely understood, it is believed that a sufficiently large amount of encapsulated active calcium hydroxide in communication through a permeable substrate to an outer surface of the product or coating communicates sufficient high alkalinity to have a biocidal effect on microorganisms there. Further, because the encapsulation invention protects the calcium hydroxide from carbonation, the calcium hydroxide's biocidal activity and the biocidal activity of the resultant product is extended for a useful period of time.

Particle size, surface charge and the composition of the encapsulated particle determine its properties and can be varied as required by the intended use. Nanoparticles or microparticles with calcium hydroxide cores may have a surface designed to adhere to a desired target surface, such as skin or other organic tissue. It may be useful to incorporate humectant in such mixtures to more readily communicate the alkalinity to the target surface A preferable humectant for the invented calcium hydroxide coating is 15% glycerin by weight. Other useful humectants are: vegetable oils, ammonium chloride, calcium chloride, sodium sulfate, aluminum sulfate, sodium acetate, and hydrous salts. Humectants like glycerin and ethylene glycol are not compatible with the hydrocarbon binder of the invented calcium hydroxide coating described in the parent patents. Suitable humectants for an organic base coating include organically soluble polyalkylene glycols, among others. Propylene glycol and polypropylene glycol are useful humectants, but are not as aggressive as glycerin. The design of humectants per se is well-known, particularly to those of ordinary skill in the cosmetic industry. The cosmetic industry often uses humectants to maintain a high level of moisture on the surface of the skin. The use of humectants to facilitate the killing effect of calcium hydroxide, however, is surprising.

Another advantage of some of the encapsulated calcium hydroxide systems is that preparations containing particles of 100 nm may appear opaque and those containing particles of 60 nm or less may result in a clear dispersion. These are particularly applicable to topical healing treatments and cosmetic preparations. In another example, nanoencapsulated calcium hydroxide may be transparent for inclusion with transparent plastics. If the nanoparticle outer layer is comprised of an hydrophobic material, the nanoparticles may make the resultant product long lived in the presence of water. This may produce products which retain their biocidal activity after repeated washings with water.

Many early soaps for use by humans were lye-based. However, the cosmetic industry typically does not now produce high alkalinity soaps. A novel use for the lime-based biocidal system disclosed herein is high lime, high pH soap for use specifically when a biocidal soap is desired to kill fungi, mold spores or other hard to kill organisms. A non-ionic soap, such as a glycerin-based soap, combined with an appropriate amount of surfactants and calcium hydroxide, may produce a useful bar of soap with an alkalinity of approximately pH12 or greater, preferably pH12.4 to 12.5. The glycerin or similar carrier prevents the calcium hydroxide from becoming neutralized from contact with atmospheric carbon dioxide. The soap's biocidal shelf life is thus very long, lasting years. When the soap is used, i.e., combined with water and rubbed back and forth, the water plus the moist calcium hydroxide provide the extremely high alkalinity needed to provide the biocidal killing system discussed herein sufficient to kill microbes, including spores.

It is hypothesized that the described soap with sufficient calcium hydroxide to provide a high alkalinity of approximately pH12 or more when used will be useful for persons such as postal workers or medical personnel to scrub down with at the end of their shift for a thorough killing of bacteria and other organisms, even including hard to kill spores, such as anthrax. Topical application of such a soap is hypothesized to be effective in treating warts, acne, athletes foot, fungus and other surface and just-below-the-surface maladies which are caused by hard to kill foreign microbes. Creams for such uses may be preferably applied for seven to ten days to the skin although experimentation will be used to vary pH and duration.

Calcium hydroxide, a proven and unique antimicrobial agent, unique in its broad spectrum killing ability in concert with its benign safe and non-toxic properties, has been incorporated into a binder which preserves the hydroxide properties for many years when applied as a topical coating. The potential uses of such coatings are vast and include all indoor surfaces where allergens and microbes accumulate and proliferate. Hydrated lime is so innocuous that it can be taken orally as a source of calcium, applied in the mouth during the restoration and treatment of cavities, applied to fungal and viral infection such as black toe, skin tags, and warts with amazing remedial benefits. Workers who inhaled the dusts have reported recovery from TB and it is used in developing countries to purify cholera-laden water. Its use to disinfect imported produce is also well known.

This ubiquitous mineral has a potential to turn the tide in the war against disease, a war that microbes are winning as they evolve, mutate, and as new forms emerge from burning rain forest, volcanism, and earthquakes.

Hydrated lime-based products may be delivered in microcapsular form (by spray drying the BNA latex), or in gel or paste form by reducing the concentration of the water vehicle in the BNA latex or as a truly water soluble, water removable, topical anti-microbial medication. It is also amenable to use as a mouthwash or a vaginal douche to counter local infections, otherwise requiring dangerous and painful medication. Soluble lime (limewater) contains fractional percentages (0.15%) of calcium hydroxide but offers a mild-to-the skin but aggressive antiseptic media for control of bacteria, viruses, and fungi. The alkaline earth, hydrated lime, in saturated solution has pH of 12.454 and qualifies as an alkaline but not as a caustic mineral unlike sodium, potassium, and other alkali metal hydroxides. The low solubility alkaline earth hydroxides of calcium, magnesium, barium, etc., are mild bases compared to the highly soluble alkali metal hydroxides.

Orally applied, limewater rinses may enhance dental enamel and facilitate formation and restoration of hydroxy apatite while destroying harmful bacteria that cause cavities and oral invections.

It is the only known anti-microbial agent that is aggressively destructive to microorganisms but seemingly benign to man and animals. The mechanism of the attack on microbes (enzyme denaturalization and incapacitation) is rapidly reversible when applied to animal tissue but not to microbes.

Hydrated lime, whether water soluble BNA or as slurry, paste, or a capsule has a potential to dramatically destroy infectious microorganisms. Candidas infections have become ubiquitous, acquiring many forms of disease both topical and systemic. Hydrated lime has shown to remove warts, toe and foot fungus, skin tags, and can potentially counter the vesicating effects of poison ivy, poison oak, and poison sumac by neutralizing the toxins therein when applied to ants, scorpions, jellyfish, and warts as a paste, the acidic toxins (formic acids) are neutralized and the painful bites and stings arrested.

Prosthetic dentures and dental restoratives comprising acrylate polymers tolerate significant levels of lime as filler and offer long-term, anti-microbial protection. Dentures culture bacteria from food residues during the waking day and, if not well cleaned, continue to culture overnight. Hydrated lime imparts a continuous low level of leaching from the denture into the mouth, sufficient to suppress bacterial passage and growth.

By gradual release of hydrated lime into the vascular system, viral and bacterial levels are controlled but not eliminated, allowing the immune system to prevail and succeed. Examples of dentures and dental restoratives are:

ten to fifty percent by volume of calcium hydroxide (minus 45 microns) is blended with 50-90 percent by volume of acrylic monomer and accelerators. The cured denture or restorative exhibits a surface pH of 11-12 when tested with hydrion paper when applied for one or two seconds to the substrate. No indicate of oral irritation so far has been observed by acrylics containing lime applied orally.

BNA-W, a water-soluble form of BNA applied daily to skin tags or to warts will safely remove both in approximately two weeks without consequence to the surrounding tissue.

BAN-L applied to black fungus toenails and allowed to persist for seven days before removal with solvent (xylene or acetone) will destroy the fungus and restore the natural color. BNA latex may be reapplied if the effect is not completed in one week and as long as 2-3 weeks without removal by daily showering or bathing. Subsequent removal can then be effected by acetone or xylene without negative consequences.

A 0.1 percent suspension of calcium hydroxide in distilled water provides an oral and vaginal rinse to destroy viral, fungal, and bacterial cultures. A water rinse for oral and or dilute vinegar rinse for oral and vaginal douche is optional.

This invention, in conclusion, can be summarized as identifying new and effective applications of calcium hydroxide through the incorporation of a carbon dioxide inhibiting vehicle for use in oral and medicinal applications whether microencapsulated or delivered in gel or paste form or dilute acueous solutions. As mouth washes, lime offers a safe, effective, and beneficial method of destroying microorganism that causes infection or dental caries. Delivered in cellulosic modified slurry and applied to genital infections (vaginal and otherwise) with a following of vinegar douche, and water rinse, lime provides the possibility of effectively controlling and destroying bacterial, fungal, and viral infections that otherwise require much more aggressive and painful treatments. Hydrated lime offers numerous health benefits in food processing and packaging and can greatly improve the sanitation and environment of areas where microbial grown and contamination are typically threatening.

Prosthetic implants comprising conventional acrylic polymers would be well served by the addition of BNA or lime in judicious amounts. A steady, slow leaching of calcium hydroxide into surrounding tissue would provide a barrier to microbial growth, especially soon after the surgery, and a continuous supply of serum-critical calcium to mitigate bone loss and subsidize nutritional sources. Such prosthetics would not be regionally limited but could include all areas of the body, mandibular, pelvic, spinal, etc.

Those with skill in the art will appreciate that materials other than cellulose will meet these requirements. Those with skill in the art will understand that the technology described in these patents is readily adaptable to give predictable benefits of the varieties mentioned. It is believed the disclosures of this application, when combined with the knowledge presented by these patents, will enable those with skill in the art to understand how to make biocidal encapsulated or unencapsulated nanoparticles and microparticles of calcium hydroxide without undue experimentation.

In using the inventions with certain products such as dental fillings, dentifrices, and topical ointments to give them biocidal properties one can utilize prior art conventional formulations and incorporate therein nano-sized particles of calcium hydroxide in an amount sufficient to give them extended biocidal activity. The optimum amount for any given composition can be readily determined by routine experimentation by testing the efficacy of the compositions against known test microorganisms and known accelerated aging tests. The prior patents noted above relating to testing paints for these purposes give additional guidance.

By way of further example topical ointments to which varying levels of nano-sized particles of calcium hydroxide have been added to give them biocidal activity are placed in containers, such as jars or tubes conventionally used for such purpose. They are then coated onto test surfaces to the thickness used for conventional non-biocidal ointments and the known test micro-organisms to determine the optimum biocidal amount of the nano-sized calcium hydroxide to use. These jars and tubes can also be subjected to accelerated aging test and periodically tested as noted above to determine how long the compositions maintain the desired level of biocidal activity. It will be obvious that these same tests can be used to determine the operative range of nanometer sizes and the optimum size for all the biocidal compositions of this invention. One aspect of this example includes a biocidal encapsulated particle and methods described above. In a preferred embodiment, the biocidal compositions containing effective hydrated lime nanoparticles in biocidally effective amounts as disclosed and described herein. Additionally, the methods of making biocidal compositions comprising hydrated lime nanoparticles in an amount effective to exert biocidal activity as disclosed and described herein.

### Example 19

### Other Embodiments.

The invented calcium hydroxide materials may be contained in detergents, liquid soaps, toothpaste, shampoos and skin creams where their topical application the body is useful for killing microbes there.

In agriculture, a substantial amount of harvested crops are lost due to mold. A particular advantageous application is in sealed areas where harvested crops are stored. For example, corn and other grains are often stored in enclosed silos from which the air is evacuated and replaced with nitrogen. One invented method of preserving harvested crops from mold, fungus and other microbes is to spray the crops with a fine mist of lime and water as they are being funneled into the silo. Because nitrogen displaces carbon dioxide containing air, the lime remains biocidally active for a sufficient period of time to retard the spread of mold, fungus and other undesirable microbes within the stored crop.

An additional use for the invented coating is to spray a thin layer of the same on crops in the field to inhibit microbial pests. The alkalinity of the lime is being protected by the invented thin cellulose coating which prevents the lime from combining with carbon dioxide.

The remediation of lead based painted homes and buildings, which are now required by environmental law to be stabilized or removed in the interest of health, particularly children's health. This results from the dusting of lead based paint particles floating in the air, and being inhaled and in addition to children chewing on the sweet tasting painted surfaces. Remediation of lead based paint is a complicated, environmentally and health damaging in addition to being expensive proposition. All wastes are required to be deposited in hazardous waste landfills. Using Caliwel to cover over lead based paint would seal the surfaces and would also react with any free lead, converting it into the insoluble compound Calcium plumbate, which becomes a non-toxic surface thereafter.

While the invention has been described in connection with preferred embodiments it is not intended to limit the scope of the invention of the particular form set forth but, on the contrary, it is intended to cover such alternatives, modifications, and equivalents as may be included within the spirit and scope of the invention as defined by the appended claims.

### SUMMARY

Description of Test 1. Used Dilution Test—10 replicates of Salmonella choleraesuis and Pseudomonas aeruginose were exposed to BNA-treated test materials for 10 minutes; 10 replicates of Staphylococcus aureus were exposed for 20 minutes. Results of Test 1, Salmonella and Pseudomonas 10 of 10 positive carriers eliminated after 10 minutes. Staphylococcus, 10 of 10 positive carriers eliminated after 20 minutes

Description of Test 2. Wet and dry inoculums of Staphylococcus aureus and Pseudomonas aeruginose were exposed to BNA for one hour (10 replicates each). Results of Test 2, Staphylococcus; Dry→99.91% average reduction; Wet—99.93% average reduction; Pseudomonas, Dry and Wet→99.99% average reduction

Description of Test 3. BNA was applied to plastic sheeting and tested for its ability to inactivate three viruses: poliovirus type 1, Herpesvirus hominis type 1 and parainfluenza virus type 3; Samples of the viruses were collected after exposure to BNA for 0, 5, 10, 15, 30 and 60 minutes and tested for amount of infectious virus present. Results of Test 3, Poliovirus—Inactivated in 15 minutes. Herpesvirus hominis.—inactivated in 10 minutes (90% in 5 minutes). Parainfluenza virus inactivated in 60 minutes.

Description of Test 4. Three pine panels, coated on all sides with BNA, were exposed to three types of fungi, Aureobasidium Pullulans, Aspergillus and Penicillium, and incubated for four weeks. Results of Test 4, two of the three panels had no fungal growth. One panel had an isolated spot of fungal growth.

Description of Test 5. Three samples of filter paper disks coated with BNA were exposed to Pseudomonas Aeruginosa and incubated for four weeks. Results of Test 5, no visible growth of bacteria on or under each of the samples.

Description of Test 6. Cardboard coupons were coated with BNA and exposed to Stachybotras chartarum and incubated for 28 days. Coupons were incubated both paint side up and paint side down. Results of Test 6, no fungal growth of any sort was observed, even for those coupons with the painted side down

Field Effectiveness Testing. Accelerated aging tests proved effective anti-microbial surface activity beyond six years. At least 60% biocide remains active, while preserving the original pH. For Example, after 7 days of exposure 78.1% residual biocide; after 1 month of exposure 77.5% residual biocide; after 6 months of exposure 71.3% residual biocide; after 10 months of exposure 70.3% residual biocide; after 42 months of exposure 69.8% residual biocide. Additional study indicated effectiveness against Bacillus subtilus and Anthrax.

### REFERENCES CITED

The following references, to the extent that they provide exemplary procedural or other details supplementary to those set forth herein, are specifically incorporated herein by reference.

### U.S. PATENT DOCUMENTS

U.S. Pat. No. 6,280,509, titled “Biocidal Coating Compositions and Method,” issued to Mallow on Aug. 28, 2001.
U.S. Pat. No. 6,231,650, titled “Biocidal Coating Composition,” issued to Mallow, et al. on May 15, 2001.
U.S. Pat. No. 6,042,638 , titled “Biocidal Coating Composition,” issued to Mallow, et al. on Mar. 28, 2000.
U.S. patent application Ser. No. 10/476,732 titled “Stabilized Biocidal Coating Composition and Method” with Mallow et al., listed as inventors and filed on Jun. 1, 2004.

What is claimed:

1. A heating ventilation and air conditioning (“HVAC”) system having bacterial spore, viral, and fungal killing activity comprising:
the HVAC system component at least partially coated with a biocidal composition comprising:
(i) a hydrated lime;
(ii) a soluble binder polymer mixture; and
(iii) a humectant;
wherein the hydrated lime, the soluble binder polymer mixture and humecatant are mixed in an organic based- or water based-solvent system useful for coating HVAC system components; a ratio of lime to soluble binder polymer being about 1:1 to about 1:3, and the humectant being 15.5% to 25% wt percent of the chemical coating; and
the chemical coating being permeable to water and impermeable to carbon dioxide.

2. The HVAC system components of claim 1, wherein the HVAC system components having the biocidal coating comprises: return air chamber; fresh air chamber mixing box air chamber; coils coil compartment; fan housing; humidifier chamber; dehumidifier chamber; spray eliminator; filters housing; louvers; HVAC supply and return ductwork; dampers turning vanes; exhaust ducts; dampers; baffles; filters; fans fan housings; and wall floor registers ceiling diffusers.

3. The HVAC system components of claim 1, wherein the bacterial spore, viral, and fungal killing activity is effective against anthrax spores; pseudomonas aeruginosa; staphylococcus aureus; samonella cholerasuis; escherichia coli; streptococcus faccialis??; klebsiella phneumonia; legionella pneumophila; alternaria alternate; aspergillus spp.; clodosporium spp.; aureobasidium pullulans; Penicillium funicullatum; stachybotras chartarum; influenza type A2; rhinovirus; rotavirus; adenovirus type 2; respiratory syncytial hepatitis; polio virus type I herpes virus hominis type I; parainfluenza virus type III.

4. The HVAC system components of claim 1, wherein the soluble binder polymer mixture comprises: water soluble polyalkylene oxides and hydroxylated or carboxylated cellulose-derived polymers, and salts of cellulosic acids and carboxyalkyl-derivatives of cellulose, carboxyethylcellulose, carboxymethylcellulose, and carboxyhydroxycellulose.

5. The HVAC system components of claim 1 wherein the soluble binder polymer mixture comprises: organic soluble cellulose-derived polymers, alkyl celluloses, cellulose ethers, esters of cellulose, cellulose acetate, cellulose butyrate, ethylcellulose, and organically soluble polyethylene glycols.

6. The HVAC system components of claim 1, wherein the humectants are water soluble and comprises: glycerin; vegetable oils, ammonium chloride, calcium chloride, sodium sulfate, aluminum sulfate, sodium acetate, hydrous salts.

7. The HVAC system components of claim 1, wherein the humectants comprises: polyalkylene glycols, propylene glycol and polypropylene glycol.

8. The HVAC system components of claim 1, further comprising about 35 percent to about 40 percent latex.

9. A garment having bacterial spore, viral, and fungal killing activity comprising:
the garment having a first side and a second side, wherein the first side is substantially coated with a biocidal composition comprising:
(i) a hydrated lime;
(ii) a soluble binder polymer mixture; and
(iii) a humectant;
wherein the hydrated lime, the soluble binder polymer mixture and humecatant are mixed in an organic based- or water based-solvent system useful for coating garments; a ratio of lime to soluble binder polymer being about 1:1 to about 1:3, and the humectant being 15.5% to 25% wt percent of the chemical coating; and the chemical coating being permeable to water and impermeable to carbon dioxide; and
wherein the second side of the garment is substantially free from the biocidal composition.

10. The garment of claim 9, wherein the garment having the biocidal coating comprises: aprons, pants, shirts, jackets, coats, gowns, gloves, hats, shoes, boots, and socks.

11. The garment of claim 9, wherein the first side comprises the outside of the garment and the second side comprises the inside of the garment.

12. The garment of claim 9, wherein the bacterial spore, viral, and fungal killing activity is effective against anthrax spores; pseudomonas aeruginosa; staphylococcus aureus; samonella cholerasuis; escherichia coli; streptococcus faccialis; klebsiella phneumonia; legionella pneumophila; alternaria alternate; aspergillus spp.; clodosporium spp.; aureobasidium pullulans; Penicillium funicullatum; stachybotras chartarum; influenza type A2; rhinovirus; rotavirus; adenovirus type 2; respiratory syncytial hepatitis; polio virus type I herpes virus hominis type I; parainfluenza virus type III.

13. The garment of claim 9, wherein the soluble binder polymer mixture comprises: water soluble polyalkylene oxides and hydroxylated or carboxylated cellulose-derived polymers, and salts of cellulosic acids and carboxyalkyl-derivatives of cellulose, carboxyethylcellulose, carboxymethylcellulose, and carboxyhydroxycellulose.

14. The garment of claim 9, wherein the soluble binder polymer mixture comprises: organic soluble cellulose-derived polymers, alkyl celluloses, cellulose ethers, esters of cellulose, cellulose acetate, cellulose butyrate, ethylcellulose, and organically soluble polyethylene glycols.

15. The garment of claim 9, wherein the humectants are water soluble and comprises: glycerin; vegetable oils, ammonium chloride, calcium chloride, sodium sulfate, aluminum sulfate, sodium acetate, hydrous salts.

16. The garment of claim 9, wherein the humectants comprises: polyalkylene glycols, propylene glycol and polypropylene glycol.

17. The garment of claim 9, further comprising about 35 percent to about 40 percent latex.

18. A hospital room article having bacterial spore, viral, and fungal killing activity comprising:
the hospital room article coated with a biocidal composition comprising:
(i) a hydrated lime;
(ii) a soluble binder polymer mixture; and
(iii) a humectant;
wherein the hydrated lime, the soluble binder polymer mixture and humecatant are mixed in an organic based- or water based-solvent system useful for coating the hospital room article; a ratio of lime to soluble binder polymer being about 1:1 to about 1:3, and the humectant being 15.5% to 25% wt percent of the chemical coating;
and the chemical coating being permeable to water and impermeable to carbon dioxide, and wherein the hospital room article comprises: handles; medical equipment; desks; computer keyboards; plastic covers for computer keyboards;
privacy curtains; window blinds; window curtains; hospital furniture; or janitorial equipment.

19. The hospital room article of claim 18, wherein the bacterial spore, viral, and fungal killing activity is effective against anthrax spores; pseudomonas aeruginosa; staphylococcus aureus; samonella cholerasuis; escherichia coli; streptococcus faccialis; klebsiella phneumonia; legionella pneumophila; altemaria alternate; aspergillus spp.; clodosporium spp.; aureobasidium pullulans; Penicillium funicullatum; stachybotras chartarum; influenza type A2; rhinovirus; rotavirus; adenovirus type 2; respiratory syncytial hepatitis; polio virus type I herpes virus hominis type I; parainfluenza virus type III.

20. The hospital room article of claim 18, wherein the soluble binder polymer mixture comprises: organic soluble cellulose-derived polymers, alkyl celluloses, cellulose ethers, esters of cellulose, cellulose acetate, cellulose butyrate, ethylcellulose, and organically soluble polyethylene glycols.

21. The hospital room article of claim 18, wherein the humectants are water soluble and comprises: glycerin; vegetable oils, ammonium chloride, calcium chloride, sodium sulfate, aluminum sulfate, sodium acetate, hydrous salts.

22. The hospital room article of claim 18, wherein the humectants comprises: polyalkylene glycols, propylene glycol and polypropylene glycol.

23. The hospital room article of claim 18, further comprising about 35 percent to about 40 percent latex.

24. A food storage container having bacterial spore, viral, and fungal killing activity comprising:
the food storage container coated with a biocidal composition comprising:
(i) a hydrated lime;
(ii) a soluble binder polymer mixture; and
(iii) a humectant;
wherein the hydrated lime, the soluble binder polymer mixture and humecatant are mixed in an organic based- or water based-solvent system useful for coating a food storage container; a ratio of lime to soluble binder polymer being about 1:1 to about 1:3, and the humectant being 15.5% to 25% wt percent of the chemical coating; and
the chemical coating being permeable to water and impermeable to carbon dioxide, and wherein the food storage container comprises: a plastic container, a metal container, a plastic tray, a metal tray, a paper bag, or a plastic bag.

25. The food storage container of claim 24, wherein the bacterial spore, viral, and fungal killing activity is effective against anthrax spores; pseudomonas aeruginosa; staphylococcus aureus; samonella cholerasuis; escherichia coli; streptococcus faccialis; klebsiella phneumonia; legionella pneumophila; alternaria alternate; aspergillus spp.; clodosporium spp.; aureobasidium pullulans; Penicillium funicullatum; stachybotras chartarum; influenza type A2; rhinovirus; rotavirus; adenovirus type 2; respiratory syncytial hepatitis; polio virus type I herpes virus hominis type I; parainfluenza virus type III.

26. The food storage container of claim 24, wherein the soluble binder polymer mixture comprises: organic soluble cellulose-derived polymers, alkyl celluloses, cellulose ethers, esters of cellulose, cellulose acetate, cellulose butyrate, ethylcellulose, and organically soluble polyethylene glycols.

27. The food storage container of claim 24, wherein the humectants are water soluble and comprises: glycerin; vegetable oils, ammonium chloride, calcium chloride, sodium sulfate, aluminum sulfate, sodium acetate, hydrous salts.

28. The food storage container of claim 21, wherein the humectants comprises: polyalkylene glycols, propylene glycol and polypropylene glycol.

29. The food storage container of claim 21, further comprising about 35 percent to about 40 percent latex.

30. A composition having bacterial spore, viral, and fungal killing activity comprising:
(i) a hydrated lime;
(ii) a soluble binder polymer mixture;
(iii) a humectant;
(iv) hydrogen peroxide; and
(v) colloidal silver;
wherein the hydrated lime, the soluble binder polymer mixture, humecatant, hydrogen peroxide, and colloidal silver are mixed in an organic based- or water based-solvent system useful as a chemical coating; a ratio of lime to soluble binder polymer being about 1:1 to about 1:3, and the humectant being 15.5% to 25% wt percent of the chemical coating; and the chemical coating being permeable to water and substantially impermeable to carbon dioxide.

31. A composition having bacterial spore, viral, and fungal killing activity comprising:
(i) a hydrated lime;
(ii) a soluble binder polymer mixture; and
(iii) a foam carrier;
wherein the hydrated lime, the soluble binder polymer mixture, and foam carrier are mixed in a water based-solvent system useful as a foam decontaminating agent; a ratio of lime to soluble binder polymer being about 1:1 to about 1:3, and the a foam decontaminating agent being substantially impermeable to carbon dioxide.

32. A method for decreasing bacterial spore, viral, or fungal content of air in a room comprising:
circulating air from the room through a filter or a baffle having a biocidal chemical coating comprising:
(i) a hydrated lime;
(ii) a soluble binder polymer mixture; and
(iii) a humectant;
wherein the hydrated lime, the soluble binder polymer mixture and humecatant are mixed in an organic based- or water based-solvent system useful for coating a filter or baffle; a ratio of lime to soluble binder polymer being about 1:1 to about 1:3, and the humectant being 15.5% to 25% wt percent of the chemical coating; and the chemical coating being permeable to water and substantially impermeable to carbon dioxide.

33. A method for killing termites in a tree comprising:
Painting the base of a tree having termites with a biocidal coating comprising:
(i) a hydrated lime;
(ii) a soluble binder polymer mixture; and
(iii) a humectant;
wherein the hydrated lime, the soluble binder polymer mixture and humecatant are mixed in an organic based- or water based-solvent system useful for coating the tree base; a ratio of lime to soluble binder polymer being about 1:1 to about 1:3, and the humectant being about 0% to about 25% wt percent of the chemical coating; and the chemical coating being permeable to water and substantially impermeable to carbon dioxide.

34. A method of making calcium plumbate from a lead based paint comprising:
covering the lead based paint with a biocidal coating comprising:
(i) a hydrated lime;
(ii) a soluble binder polymer mixture; and
(iii) a humectant;
wherein the hydrated lime, the soluble binder polymer mixture and humecatant are mixed in an organic based- or water based-solvent system useful for coating the lead based paint; a ratio of lime to soluble binder polymer being about 1:1 to about 1:3, and the humectant being about 0% to about 25% wt percent of the biocidal coating; and the biocidal coating being permeable to water and substantially impermeable to carbon dioxide.
